(19) United States
(12) Patent Application Publication
(10) Pub. No.: US 2015/0352561 A1
(43) Pub. Date: Dec. 10, 2015

(54) Method and Apparatus for Conditioning Fluids

(71) Applicant: WILSA, INC., Houston, TX (US)

(72) Inventor: Herbert William HOLLAND, Houston, TX (US)

(73) Assignee: Wilsa Holdings ,LLC

(21) Appl. No.: 14/758,436

(22) PCT Filed: Jan. 2, 2014
(86) PCT No.: PCT/US2014/010100

§ 371 Date: Jun. 29, 2015

Related U.S. Application Data
(60) Provisional application No. 61/748,389, filed on Jan. 2, 2013.

(51) Int. Cl. B03C 1/14

(52) U.S. Cl. CPC B03C 1/14

(57) ABSTRACT

A method of increasing the rate by which a dissimilar material separates in a fluid mixture is disclosed. The method includes the step of passing a first fluid mixture containing at least one polar substance and at least one dissimilar material through a magnetically conductive conduit having magnetic energy directed along the longitudinal axis of the magnetically conductive conduit and extending through at least a portion of the first fluid mixture thereby providing a conditioned fluid medium. The conditioned fluid medium is separated into at least two distinct phases in a separation apparatus downstream of the magnetically conductive conduit, wherein the at least one dissimilar material separates from the conditioned fluid medium at an increased rate as compared to a rate of separation of the at least one dissimilar material from the first fluid mixture.

### INCORPORATION BY REFERENCE

The present patent application claims priority to and hereby incorporates by reference the entire content of United States Provisional patent application identified by U.S. Ser. No. 61/748,389 filed on Jan. 2, 2013 and titled “Method and Apparatus for Conditioning Fluids.”

### BACKGROUND

There are many practical advantages to improving phase separation, blending distinct phases into a homogenous mixture, increasing the flow rate of fluid propelled at a constant pressure, and/or reducing the pressure required to propel a fluid at a constant flow rate.

A phase is defined as a region of material in a thermodynamic system that is physically distinct, chemically uniform, and typically mechanically separable. The three common states of matter are historically known as solid, liquid and gas; with their distinction commonly based on qualitative differences in the bulk properties of the phase in which each exists. A solid phase maintains a fixed volume and shape. A liquid phase has a volume that varies only slightly but adapts to the shape of its container. A gas phase expands to occupy the volume and shape of its container.

Physical properties of a phase do not change the chemical nature of matter and are traditionally defined by classic mechanics that include, but are not limited to, area, capacitance, concentration, density, dielectric, distribution, efficacy, elasticity, electric charge, electrical conductivity, electrical impedance, electric field, electric potential, electromagnetic absorption, electromagnetic permittivity, emission, flexibility, flow rate, fluidity, frequency, hardness, inductance, intrinsic impedance, intensity, irradiation, magnetic field, magnetic flux, magnetic moment, mass, opacity, permeability, physical absorption, pressure, radiance, resistivity, reflectivity, solubility, specific heat, temperature, tension, thermal conductivity, velocity, viscosity, volume, and wave impedance. Phases may also be differentiated by solubility, the maximum amount of a solute that can dissolve in a solvent before the solute ceases to dissolve and remains in a separate phase. Water (a polar liquid) and oil (a non-polar liquid) can be separated into two phases because water has very low solubility in oil, and oil has a low solubility in water. The concept of phase separation also extends to the separation of solids from liquids, solids from vapors, and liquids from vapors.

Efficient mechanical separation and physical separation have a number of practical applications. In oilfield applications, for example, crude oil, gas, water, and solid contaminants extracted from oil producing formations are directed through bulk recovery apparatus in order to recover marketable hydrocarbons. Crude oil and gas containing residual amounts of water and other contaminants are then transported to processing facilities while the water and solids are processed for disposal. Some water extracted in the bulk recovery process may be injected into an oil producing formation in order to maintain the pressure in the oil producing formation while other water may be processed for reuse after removing trace amounts of crude oil, gas, solids, bacteria, or other contaminants that may be present.

Thermal exchange systems utilize water as a heat transfer medium. Fouled heat exchange systems periodically undergo descaling in order to recover lost productivity resulting from reduced thermal exchange efficiency and restricted fluid flow and to reduce energy consumption. The removal of suspended and dissolved minerals from water, for example, helps reduce scale deposits and thereby “opens up” restrictions to water flow that are caused by such fouling.

In many instances, it may be advantageous to alter the dispersive surface tension and the polar surface tension of a fluid in order to improve mechanical blending of two or more distinct phases into a homogenous mixture. For example, it is oftentimes desirable to blend food products into homogenous mixtures (e.g., milk, ketchup, etc.) that will not readily separate into distinct phases over time and/or during transport or storage.

A solid phase (e.g., bentonite) and a liquid phase (e.g., water) along with other additives may be blended to form drilling fluids used in oil and gas exploration and production. Such “drilling mud” provides hydrostatic pressure that prevents formation fluids from entering a wellbore, keeps drill bits cool during drilling while also extracting drill cuttings from the wellbore, and/or suspends drill cuttings whenever the drilling assembly is brought in and out of the hole. Homogenous mixtures of drilling mud improve the efficiency of pumps that circulate such fluids and also increase the efficiency of screens, shakers, and other apparatus downstream of the wellbore that extract drill cuttings (for example) from the drilling mud.

The ability to alter at least one physical property of a fluid flowing under pressure (e.g., increasing the flow rate of fluid propelled at a constant pressure, or reducing the pressure required to propel a volume of a fluid mixture at a constant flow rate) may also increase productivity and reduce fluid processing costs.

### SUMMARY

The presently claimed and/or disclosed inventive concepts for conditioning fluids includes the step of directing a fluid mixture containing at least one polar substance through a magnetically energized conduit in order to provide a magnetically conditioned fluid. In some instances, the magnetically conditioned fluid may then be directed to pass through a separation apparatus. Such magnetically conditioned fluid is found to have improved efficiency of oil/water separation, water/solids separation, and oil/water/solids separation as well as an increased rate by which a fluid mixture separates into at least two distinct phases.

The presently claimed and/or disclosed inventive concepts may also be utilized to alter a dispersive surface tension and a polar surface tension of a fluid to improve mechanical blending or alter at least one physical property of a fluid flowing under pressure; and require little monitoring or adjustment for effective fluid conditioning.

### BRIEF DESCRIPTION OF THE DRAWINGS

FIG. 1 is a schematic diagram of a magnetically conductive conduit and a separation apparatus.

FIG. 1A is a schematic diagram of a magnetically conductive conduit and a separation apparatus.

FIG. 1B schematically depicts a magnetically conductive conduit disposed within a separation apparatus.

FIG. 2 schematically depicts the flow of magnetic flux loops encircling a length of magnetically energized conduit.

FIG. 3 and FIG. 3A schematically depict magnetically conductive conduits and embodiments of non-magnetically conductive fluid flow conduits.

FIG. 4 and FIG. 4A schematically depict serial couplings of conduit segments and embodiments of non-magnetically conductive fluid flow conduits.

FIG. 5 schematically depicts a non-contiguous array of magnetically conductive conduits sleeving a non-magnetically conductive fluid flow conduit.

FIG. 6 schematically depicts an apparatus for altering surface tensions of a fluid as disclosed herein.

FIG. 6A schematically depicts an apparatus for altering physical properties of a fluid flowing under pressure as disclosed herein.

FIG. 7 is an exploded view of a first magnetically conductive conduit adapted to sleeve a second magnetically conductive conduit.

FIG. 7A is an exploded view of a first magnetically conductive conduit adapted to sleeve a non-contiguous array of magnetically conductive conduits.

FIG. 7B is an exploded view of a first magnetically conductive conduit adapted to sleeve a serial coupling of conduit segments.

FIG. 7C is an exploded view of a first serial coupling of conduit segments adapted to sleeve a second serial coupling of conduit segments.

FIG. 8 schematically depicts a magnetically conductive nucleus disposed within a non-magnetically conductive conduit segment.

FIG. 9 schematically depicts a magnetically conductive nucleus disposed within a non-magnetically conductive fluid flow conduit.

FIG. 10 is a graph showing changes in ultrasound attenuation over time during dissolution of MPC80 in a first sample of water subjected to no magnetic conditioning, a second sample of water subjected to positive magnetic conditioning, and a third sample of water subjected to negative magnetic conditioning.

FIG. 11 schematically depicts a magnetically conductive nucleus supported by a non-magnetically conductive material within a conduit segment to form a static mixing device within the fluid flow path extending through the conduit segment.

### DETAILED DESCRIPTION

Stokes's Law describes the physical relationship that governs the settling of solid particles in a liquid; and similarly governs the rising of light liquid droplets within a different, heavier liquid. Stokes's Law relates to the terminal settling, or rising, velocity of a smooth, rigid sphere having a known diameter through a viscous liquid of known density and viscosity when subjected to a known force (gravity). A modified version of Stokes's Law that accounts for a constant flow of a fluid mixture through a separator is: V=(2 gr²)(d1−d2)/9μ, where V=velocity of rise (cm/sec), g=acceleration of gravity (cm/sec²), r=“equivalent” radius of a particle (cm), d1=density of a particle (g/cm³), d2=density of the fluid medium (g/cm³), and p=viscosity of the fluid medium (dyne/sec/cm²).

Specific gravity is the ratio of the density (mass of a unit volume) of a first substance to the density (mass of the same unit volume) of a reference substance, which is nearly always water for liquids or air for gases. Specific gravity is commonly used in industrial settings as a simple means of obtaining information regarding the concentration of solutions of various materials. Temperature and pressure must be specified for both the substance and the reference when quantifying the specific gravity of a substance with pressure typically being 1.0 atmosphere, and the specific gravity of water commonly set at 1.0. Substances with a specific gravity of 1.0 are neutrally buoyant in water, those with a specific gravity greater than 1.0 are more dense and typically sink in water, while those with a specific gravity of less than 1.0 are less dense and typically float on water.

When the respective specific gravities of the liquids, particle size and the viscosity of the continuous phase (typically water) are known, Stokes's Law outcome for the rise of an oil droplet is equivalent to the outcome for the settling of solid particles, with a negative velocity referencing the rising velocity of a droplet. Stokes's Law assumes all particles are spherical and the same size; and flow is laminar, both horizontally and vertically, and that droplets will rise as long as laminar flow conditions prevail. Variables include the viscosity of the continuous liquid, the size of the particles and the difference in specific gravity between the continuous liquid and the particle. The utilization of magnetic conditioning according to the presently claimed and/or disclosed inventive concepts to alter a dispersive surface tension and/or a polar surface tension of water accelerates the rate by which oil and solids separate from water.

Surface tension and viscosity are not directly related; viscosity depends on intermolecular forces within the bulk of a liquid, whereas surface tension focuses more on the surface, rather than the bulk, of the liquid. Surface tension is a quantitative thermodynamic measure of the “unhappiness” experienced by a molecule of a liquid that is forced to be at the surface of a bulk of that same liquid and giving up the interactions that it would rather have with neighboring liquid molecules in the bulk of the liquid, and getting nothing in return from the gas. Surface tension is an attribute of a liquid in contact with a gas; and liquid molecules in contact with any other phase experience a different balance of forces than the molecules within the bulk of the liquid. Thus, surface tension is a special example of interfacial tension; which is defined by the work associated with moving a molecule from within the bulk of a liquid to its interface with any other phase.

Stokes's Law predicts how fast an oil droplet will rise through water based on the density and size of the oil droplet and the distance the oil must travel. The difference in the specific gravities of oil and water are significant elements in the gravity separation of oil/water mixtures. As oil droplets coalesce they do not form flocs, like solid particles, but form larger droplets. Interfacial tension works to keep the drop spherical since a sphere has the lowest surface to volume ratio of any shape, and interfacial tension is, by definition, the amount of work necessary to create a unit area of interface. As oil droplets coalesce into larger droplets, the buoyancy of the droplets increases as they rise toward the surface of the water.

Increased interfacial tension improves coalescing of oil droplets into larger drops and also causes the droplets to assume spherical shapes. While all the variables of Stokes's Law have a decided impact on separation, the greatest impact is found in the size of the particle since its relationship in the Stokes's Law equation is not one-to-one, but the square of the size. That is, as the droplet size doubles, its separation velocity increases by four times, as the droplet size triples, separation is nine times faster; and so forth. Similarly, coalescing of solids accelerates their fall.

Many gravity separation apparatus are designed using Stokes's Law to define the rising velocity of oil droplets based on their density and size and the difference in the specific gravities of oil and water, which is much smaller than the difference in the specific gravities of solids and water. Based on such design criterion, most suspended solids will settle to the bottom of phase separators as a sediment layer while oil will rise to top of phase separators and form a layer that can be extracted by skimming or other means. Water forms a middle layer between the oil and the solids. Solids falling to the bottom of a separator may be periodically removed for disposal. Heat, at least one chemical compound, or both may be introduced into the fluid mixture in order to increase its rate of phase separation.

The greater the difference in the density of an oil droplet and the density of a continuous water phase, the more rapid the gravity separation. The terminal velocity of a rising or falling particle is affected by anything that will alter the drag of the particle. Terminal velocity is most notably dependent upon the size, spherical shape and density of the particles, as well as to the viscosity and density of the fluid. When the particle (or droplet) size exceeds that which causes a rate of rising or falling greater than the velocity of laminar flow, flow around the particle becomes turbulent and it will not rise or fall as rapidly as calculated by Stokes's Law because of hydrodynamic drag. However, larger particles (or droplets) will fall or rise very quickly in relationship to smaller particles and can be removed by a properly designed separator.

Drag coefficients quantify the resistance of an object to movement in a fluid environment and are always associated with the surface area of a particle. A low drag coefficient indicates that an object has less hydrodynamic drag. Skin friction directly relates to the area of the surface of a body in contact with a fluid and indicates the manner in which a particle resists any change in motion caused by viscous drag in a boundary layer around the particle. Skin friction rises with the square of its velocity. As described herein, magnetic conditioning has been determined to alter the dispersive surface tension and/or the polar surface tension of a fluid mixture containing at least on polar substance. Such magnetic conditioning influences the viscosity of the fluid as it affects intermolecular forces within the liquid.

For dilute suspensions, Stokes's Law predicts the settling or rising velocity of small spheres in a fluid (for example, oil in water) is due to the strength of viscous forces at the surface of the particle. While such viscous forces provide the majority of the retarding force working against the inertial rise or fall of the small spheres in Stokes's Law, increased use of empirical solutions may be required to effectively calculate the drag forces on the settling or rising velocity of small spheres in dilute solutions.

While increasing particle size has the greatest impact with respect to the rate of separation calculated by Stokes's Law, altering the dispersive surface tension and/or the polar surface tension of the continuous phase (for example, by magnetically conditioning water that flows within a separator according to the presently claimed and/or disclosed inventive concepts) has a significant impact on the rate of phase separation.

The presently claimed and/or disclosed inventive concepts include an apparatus for separating at least one dissimilar material from a fluid mixture containing at least one polar substance, including a magnetically conductive conduit having magnetic energy directed along the longitudinal axis of a magnetically energized conduit and extending through at least a portion of the magnetically conductive conduit; and a separation apparatus downstream of the magnetically conductive conduit, wherein the fluid mixture containing at least one polar substance and at least one dissimilar material is capable of flowing through the magnetically conductive conduit and into a separation device.

The magnetically conductive conduit may have a fluid entry port at the proximal end of the magnetically conductive conduit, a fluid discharge port at the distal end of the magnetically conductive conduit and a fluid impervious boundary wall having an inner surface and an outer surface extending between the fluid entry port and the fluid discharge port, the inner surface of the boundary wall establishing a fluid flow path extending along the longitudinal axis of the conduit. The magnetically conductive conduit may further have at least one electrical conductor having a first conductor lead and a second conductor lead, the electrical conductor coiled with at least one turn to form at least one uninterrupted coil of electrical conductor, each coil forming at least one layer of coiled electrical conductor. The magnetically conductive conduit may further include at least one coiled electrical conductor encircling the magnetically conductive conduit within the coiled electrical conductor, wherein the at least one coiled electrical conductor sleeves at least a section of an outer surface of the boundary wall of the magnetically conductive conduit with at least one turn of the electrical conductor oriented substantially orthogonal to the fluid flow path extending through the conduit. The magnetically conductive conduit may further have at least one electrical power supply operably connected to at least one of the first and second conductor leads, wherein the at least one coiled electrical conductor is thereby energized to provide a magnetic field having lines of flux directed along a longitudinal axis of the magnetically energized conduit. As used herein, the term “magnetically energized conduit” refers to the “magnetically conductive conduit” in an energized state. The lines of flux form loops and the resulting magnetic field is of a strength that allows the flux to extend along the longitudinal axis of the magnetically energized conduit and concentrate at distinct points beyond each end of the conduit such that the magnetic flux extends from a point where the lines of flux concentrate beyond one end of the magnetically energized conduit, around the periphery of the coiled electrical conductor along the longitudinal axis of the fluid impervious boundary wall, and to a point where the lines of flux concentrate beyond the other end of the magnetically energized conduit. The boundary wall absorbs the magnetic field and the magnetic flux loops generated by the coiled electrical conductor at the points of flux concentration.

The presently claimed and/or disclosed inventive concepts include alternate embodiments having more than one length of magnetically conductive material forming the magnetically conductive conduit, each length of magnetically conductive material having a fluid entry port at the proximal end of the conduit, a fluid discharge port at the distal end of the conduit, and a fluid impervious boundary wall having an inner surface and an outer surface extending between the fluid entry port and the fluid discharge port. Magnetic flux may extend from a point where the lines of flux concentrate beyond one end of an embodiment of the magnetically energized conduit having more than one length of magnetically conductive material forming the magnetically conductive conduit, around the periphery of the coiled electrical conductor along the longitudinal axis of each magnetically conductive boundary wall and to a point where the lines of flux concentrate beyond the other end of the magnetically energized conduit. Each magnetically conductive boundary wall may absorb the magnetic field and the magnetic flux loops generated by the coiled electrical conductor at the points of flux concentration; and it can be appreciated that magnetic energy may be concentrated in a plurality of distinct areas along the longitudinal axis of embodiments of a magnetically energized conduit having more than one length of magnetically conductive material forming the magnetically conductive conduit.

Magnetically conductive coupling devices and/or segments of magnetically conductive conduit may be utilized to make fluid impervious connections with the inlet and outlet ports of the magnetically energized conduit to promote the flow of fluid through magnetic energy. Utilization of magnetically conductive couplings and conduits results in magnetic energy that would otherwise concentrate at each end of a magnetically energized conduit being absorbed by the contiguous array of magnetically conductive coupling devices and/or segments of magnetically conductive conduit. Magnetic fluid conditioning is then limited to only that region along the fluid flow path within the coiled electrical conductor sleeving an outer surface of the magnetically conductive conduit and/or concentrated in a space between two non-contiguous lengths of magnetically energized conduit in an embodiment of the magnetically energized conduit having more than one length of magnetically conductive material forming the magnetically conductive conduit, since the magnetic flux loops at each end of the magnetically energized conduit are absorbed by the contiguous array of magnetically conductive conduits and can no longer concentrate at each end of the magnetically energized conduit.

Non-magnetically conductive coupling devices and/or segments of non-magnetically conductive conduit may also be utilized to make fluid impervious connections with the inlet and outlet ports of a magnetically energized conduit to promote the flow of fluid through the magnetically energized conduit. Utilization of non-magnetically conductive materials allows the lines of flux (flowing from one end of the magnetically energized conduit to the other end of the magnetically energized conduit) to pass through the fluid impervious boundary walls of the non-magnetically conductive coupling devices and/or conduits and concentrate within the inlet and outlet ports at each end of the magnetically energized conduit so that fluid flowing through the magnetically conductive conduit receives additional magnetic conditioning in these regions. Therefore, it can be appreciated that magnetic energy is concentrated in a plurality of distinct areas along the longitudinal axis of a magnetically energized conduit when utilizing non-magnetically conductive coupling devices and/or segments of non-magnetically conductive conduit to make fluid impervious connections with the inlet and outlet ports of the magnetically energized conduit.

The separation apparatus may have at least one inlet port, at least one outlet port and a fluid impervious boundary wall extending between the at least one inlet port and the at least one outlet port.

The separation apparatus may have a fluid impervious boundary wall having an inner surface, an inlet port for receiving a magnetically conditioned fluid medium, a first outlet port for discharging a first amount of the conditioned fluid medium having a reduced volume of the at least one dissimilar material and a second outlet port for discharging the at least one dissimilar material containing a reduced volume of the conditioned fluid medium. As used herein, a separator having a capacity to separate at least one dissimilar material from a conditioned fluid medium by centrifugal force, mechanical screening, gravity separation and/or physical separation may be selected from a group consisting of, but not limited to, two-phase separation equipment, three-phase separation equipment, dewatering apparatus, dissolved air flotation apparatus, induced gas flotation apparatus, froth flotation, centrifuges, hydrocyclones, desanders, wash tanks, oil/water separators, knock-out units, clarifiers, petroleum production equipment, distillation systems, desalination equipment, reverse osmosis systems, fuel filters, lubricant filters, and combinations thereof or equivalent types of separation apparatus known to those of ordinary skill in the art.

The separation apparatus may have a fluid impervious boundary wall having an inner surface, an inlet port for receiving a magnetically conditioned fluid medium, and at least one outlet port for discharging an amount of the conditioned fluid medium containing a reduced volume of the at least one dissimilar material. As used herein, a separator having a capacity to separate at least one dissimilar material from a conditioned fluid medium by mechanical screening, gravity separation and/or physical separation may be selected from a group consisting of, but not limited to, settling tanks, gravity separators, dissolved air flotation apparatus, clarifiers, screening apparatus, water filters, fuel filters, lubricant filters, and combinations thereof or equivalent separation apparatus known to those of ordinary skill in the art. As used herein, open top pits and settling ponds having a fluid impervious boundary wall to contain a conditioned fluid medium may be included as one exemplary, but non-limiting, embodiment of the presently claimed and/or disclosed separation apparatus. A volume of the at least one dissimilar material that may be retained within a fluid impervious boundary wall of such separation apparatus may periodically be removed to provide capacity for ongoing separation of the at least one dissimilar material from the conditioned fluid medium.

A fluid mixture containing at least one polar substance and at least one dissimilar material may be directed to pass through at least one pair of electrodes energized with electrical energy. At least one pair of electrically charged electrodes may be disposed within an apparatus having a fluid impervious boundary wall having an inner surface, an inlet port for receiving a fluid mixture containing at least one polar substance and at least one dissimilar material, and at least one outlet port for discharging an amount of the fluid mixture directed to pass through an electrolysis process.

Each electrode may include at least one plate made of an electrical conducting material and having at least one conductor lead, with at least one pair of electrodes configured as a substantially parallel array of spaced-apart plates interleaving to form at least one cavity between the facing surfaces of adjacent plates. Each electrode plate may be energized with a positive or negative electrical charge opposite from its adjacent plate so that an input of controlled electrical energy to a fluid mixture flowing between charged electrodes results in physical reactions that destabilize the fluid mixture, allow the at least one dissimilar material to change form and/or accelerate its removal from the fluid. As a fluid mixture passes through charged electrodes, at least one dissimilar material within the fluid mixture may experience neutralization of ionic and particulate charges as an electrode acting as a cathode generates hydrogen and thereby also reduces the valence state of some dissolved solids, causing those materials to become less soluble or achieve a neutral valence state; and an electrode acting as an anode generates oxygen and ozone that eliminates many contaminants.

Carbon steel, aluminum, titanium, noble metals, stainless steel, and other electrically conductive materials may form the electrodes, with the composition of the fluid mixture and the desired quality of fluid conditioning typically determining the type of material used to make the electrode plates.

The conductivity of a fluid mixture is primarily dependent upon the composition and quantity of the at least one dissimilar material carried within the fluid mixture. Fluid mixtures having high percentages of suspended and dissolved materials are typically more electrically conductive, and therefore provide less resistance to the flow of electrical charges through the fluid than fluid mixtures relatively free of suspended or dissolved materials. Seawater, for example, is typically more conductive than fresh water due to its high levels of dissolved minerals. A constant flow of electrons between the electrodes is desired for effective electrolysis. In many instances, voltage supplied to the electrodes may be allowed to fluctuate with the conductivity of a fluid mixture to provide for a constant level of amperage supplied to the electrodes.

Electrodes made of non-sacrificial materials, such as stainless steel, titanium, noble metals, and/or electrically conductive materials coated or plated with one or more noble metal materials, typically do not donate ions to a fluid mixture. A fluid mixture containing at least one polar substance directed to pass through non-sacrificial electrodes may be exposed to oxygen, ozone, hydrogen, hydroxyl radicals, and/or hydrogen peroxide as a result of electrolysis of the fluid. In addition, electrolysis of the fluid mixture can eliminate many organisms and biological contaminants by altering the function of their cells. Further, electrodes made of copper and/or silver may donate ions to a fluid mixture, thereby providing residual sanitizing properties to the fluid mixture. In addition to the destruction of many pathogens, additional benefits of electrolysis include significant reductions in the odor and turbidity of an effluent, as well as lower levels of total suspended solids, total petroleum hydrocarbons, chemical oxygen demand, and/or biological oxygen demand.

An electrolysis process commonly known as electrocoagulation utilizes electrodes made of sacrificial materials that donate metal ions to a fluid mixture that tend to combine with the at least one dissimilar material to form a stable floc. For example, the fluid mixture may initially be exposed to sacrificial electrodes donating iron ions that may then combine with the at least one dissimilar material in the fluid mixture. Sacrificial aluminum electrodes may then distribute aluminum ions to coalesce with suspended contaminants (as well as iron ions already combined with suspended contaminants) to form a stable floc that can be separated from the fluid mixture. In other applications, ions of iron, aluminum, and other flocculating elements may be dispersed into a fluid mixture upstream, or downstream, of energized electrodes to initiate coalescing of the at least one dissimilar material. Chemical compounds containing contaminant coagulating elements may also be dispersed into a fluid mixture. Combining flocculants and/or coagulants with electrolysis may allow many contaminants to emerge as newly formed compound that facilitate the separation of at least one dissimilar material from the fluid mixture.

A fluid mixture exposed to electrolysis may be directed to subsequent treatment phases, if necessary, to extract any remaining contaminants. Contaminants may float to the surface of a fluid and removed by skimming, dissolved air and/or induced air flotation apparatus or equivalent separation apparatus known to those of ordinary skill in the art; or readily settle as a floc in a settling tank, gravity separator, clarifier, filter, and/or other type of separation apparatus. Electrodes may be energized with electrical energy having an alternating current component or a direct current component. When energizing electrodes with direct current, the polarity of the charge applied to such electrodes may be periodically reversed in order to reduce the plating of the surfaces of the electrodes with contaminants and also allow relatively equally degradation of sacrificial electrodes. Magnetic conditioning may be utilized upstream of an electrolysis process is disclosed herein to retard plating of electrodes. A separation apparatus of the presently claimed and/or disclosed inventive concepts may have a capacity to separate at least one dissimilar material from a fluid mixture containing at least one polar substance directed to pass through an electrolysis process.

A fluid mixture containing at least one polar substance and at least one dissimilar material may be directed to pass through a fluid treatment vessel providing pulsed fluid treatment, the fluid treatment vessel defining a fluid impervious boundary wall with an inner surface and having a fluid input port and a fluid output port, the inner surface of the fluid impervious boundary wall establishing a fluid treatment chamber.

At least one transducer may be deployed proximate the fluid treatment vessel, each at least one transducer having at least one conductor lead operably connected to at least one electrical energizing unit having a capacity to produce at least one distinct programmable output of electrical energy continuously switched on and off at a pulsed repetition rate to establish at least one pulsed electrical signal to energize the at least one transducer and thereby produce pulsed fluid treatment proximate at least one distinct region within the fluid treatment chamber.

Introducing a fluid mixture containing at least one polar substance and at least one dissimilar material receptive to pulsed fluid treatment to the fluid inlet port of the fluid treatment vessel to establish a flow of the fluid to be treated through the fluid treatment chamber; wherein the fluid is directed to pass through the at least one region of pulsed fluid treatment; and then discharged through the fluid outlet port of the fluid treatment vessel as a processed fluid.

At least one length of electrical conducting material forming at least one antenna may be disposed within the fluid impervious boundary wall of the fluid treatment vessel to form the at least one transducer. When energized with at least one pulsed electrical signal, the at least one antenna may produce at least one pulsed electromagnetic wave directing pulsed fluid treatment to at least one distinct region within the fluid treatment chamber. The at least one antenna may be directional or omni-directional in function and enclosed within a housing to protect said antenna from corrosive fluid mixtures and debris in a feed stream that could affect the performance of the antenna or destroy the antenna.

The at least one transducer may comprise at least one magnetostrictive or at least one piezoelectric transducer. Mounting these types of transducers to a diaphragm, such as the fluid impervious boundary wall a fluid treatment vessel proximate the fluid treatment chamber, and applying at least one electrical signal to energize the transducer produces at least one pulsed electromagnetic field that causes the movement of the diaphragm, which in turn causes a pressure wave to be transmitted through fluid within the fluid treatment chamber. Similarly, a transducer enveloped by a material forming a diaphragm and deployed within a fluid treatment chamber may cause a pressure wave to be transmitted through fluid within the fluid treatment chamber.

The fluid treatment vessel may be include in a processing system upstream of the magnetically conductive conduit so that a fluid mixture containing at least one polar substance and at least one dissimilar material may be directed to pass through at least one region of pulsed fluid treatment prior to passing through concentrated magnetic energy. The fluid treatment vessel may be include in a processing system downstream of the magnetically conductive conduit so that a fluid mixture containing at least one polar substance and at least one dissimilar material may be directed to pass through concentrated magnetic energy prior to passing through at least one region of pulsed fluid treatment.

The repetition rate, wavelength, amplitude and direction of the at least one pulsed electrical signal may be adjusted to treat a variety of fluids to improve the efficiency of apparatus utilized in solid/liquid phase separation or liquid/liquid separation, and controlling and eliminating many biological contaminants. The presently claimed and/or disclosed inventive concepts for conditioning fluids typically will not over treat or under treat a feedstock, requires little monitoring or adjustment for effective fluid treatment and may be utilized in either single pass or and closed-loop fluid transmission systems.

A fluid mixture may be directed to make a single pass through the magnetically conductive conduit and a single pass through the separation apparatus, or a conditioned fluid may be directed to make at least one additional pass through the magnetically conductive conduit, the separation apparatus, and/or both. At least one separation apparatus may be utilized upstream of the magnetically conductive conduit to separate at least one dissimilar material from the fluid mixture. A fluid mixture may be directed to pass through a pretreatment process, such as electrolysis and/or dispersing at least one chemical compound into the fluid, upstream of a separator to facilitate contaminant separation. A conditioned fluid medium may be directed to pass through subsequent fluid processing methods and apparatus.

A fluid mixture containing at least one polar substance and at least one dissimilar material may be directed to a collection vessel and/or pretreatment apparatus to facilitate the separation of contaminants from the fluid. A first fluid mixture may then be directed to pass through at least one magnetically conductive conduit having magnetic energy directed along the longitudinal axis of the magnetically energized conduit and extending through at least a portion of the first fluid mixture thereby providing a conditioned fluid medium, then directed to pass through a first separation apparatus having a capacity to extract readily recoverable liquid phase contaminants from the conditioned fluid medium. The conditioned fluid medium may then be directed to pass through a second separation apparatus having a capacity to extract solid phase contaminants from the conditioned fluid medium; then discharged as a conditioned fluid medium having a reduced volume of liquid phase contaminants and solids phase contaminants within the first fluid mixture. In some instances, it may be desirable to direct the conditioned fluid medium to pass through a solids phase separation apparatus prior to directing the conditioned fluid medium to pass through a liquid phase separation apparatus. Gas phase contaminants may be extracted and/or collected from the conditioned fluid medium as it passes through the liquid phase separation apparatus, the solids phase separation apparatus and/or a separation apparatus dedicated to removing gas phase contaminants from the conditioned fluid medium. The conditioned fluid medium may be directed to subsequent processing apparatus to extract any remaining dissimilar materials and/or contaminants from the fluid. At least one magnetically conductive conduit may be deployed upstream of a collection vessel, pretreatment apparatus and/or separation apparatus.

A fluid mixture containing at least one polar substance may be selected from a group including water, aqueous-based solutions, aqueous-based amalgamations, some diesel compounds, and/or combinations thereof or other fluids containing at least one polar substance known to those of ordinary skill in the art. At least one dissimilar material may be selected from a group including hydrocarbon compounds, autotrophic organisms, biological contaminants, chemical compounds, solids, fats and/or combinations thereof. Hydrocarbon compounds may include, but are not limited to, crude oil, bitumen, shale oils, mineral oils, asphalt, lubricating oils, fuel oils, hydrocarbon fuels, natural gasses, other compounds whose molecules contain carbon, and/or equivalents. Autotrophic organisms may include, but are not limited to, algaes, phototrophs, lithotrophs, chemotrophs, and other organisms that produce complex organic compounds from simple substances present in their immediate surroundings, and/or combinations and equivalents thereof. Biological contaminants may include, but are not limited to, bacteria, such as Escherichia coli, Staphylococcus aureus, Streptococcus and Legionella bacteria; protozoa, such as cryptosporidium; parasites, such as Giardia lambia; sulfate-reducing bacteria in oilfield water; plants, viruses and bacteria in marine ballast water; mildew; viruses; pollen; other living organisms that can be hazardous to animal or human health and/or combinations and equivalents thereof. Chemical compounds may include, but are not limited to, molecular compounds held together with covalent bonds, salts held together with ionic bonds, intermetallic compounds held together with metallic bonds, complexes held together with coordinated covalent bonds, other chemical substances consisting of two or more chemical elements that can be separated into simpler substances by chemical reactions, and/or combinations and equivalents thereof. Solids may include, but are not limited to, metals, minerals, ceramics, polymers, organic solids, composite materials, natural organic materials having cellulose fibers imbedded in a matrix of lignin, biomaterials, other substances having structural rigidity and resistance to changes in shape or volume, and/or combinations and equivalents thereof. Fats may include, but are not limited to, triglycerides, triesters of glycol, fatty acids, lipids, sebum, waste vegetable oils, animal fat, grease, other compounds that are generally soluble in organic solvents and generally insoluble in water, and/or combinations and equivalents thereof.

The presently claimed and/or disclosed inventive concepts have been examined and quantified. As disclosed herein in a first example, a length of new ⅛″ plastic tubing was deployed through the fluid impervious wall of an embodiment of the presently claimed and disclosed magnetically conductive conduit having a 1″ diameter boundary wall and extending through each end of the conduit to establish a fluid flow path; with the tubing being made of a material that, in and of itself, would not affect any physical properties of a fluid mixture sample. A high throughput peristaltic (non-direct contact) pump was then used to propel samples of seawater through the magnetically conductive conduit at a flow rate of 1150 ml/min. A first sample of untreated seawater was collected in a certified clean container after being directed to make only one pass through the length of non-energized magnetically conductive conduit. The sample flowed uncollected for approximately 30 to 45 seconds to allow for the dismissal of any bubbles so that the untreated seawater sample was collected during steady-state flow. A second sample of seawater was collected in a certified clean container after energizing a coiled electrical conductor encircling the conduit with 12 VDC and approximately 5 amps of electrical energy and directing the seawater to make only one pass through a magnetically energized conduit having an area of magnetic conditioning concentrated along a path extending through at least one turn of the electrical conductor encircling the outer surface of the magnetically energized conduit generating approximately 850 gauss (unit of magnetic field measurement) of magnetic energy, as well as approximately 150 gauss of magnetic energy concentrated at each end of the magnetically energized conduit. The magnetically conditioned seawater sample was similarly allowed to flow uncollected for approximately 30 to 45 seconds to allow for the dismissal of any bubbles so that the water sample was collected during steady-state flow. Overall surface tensions of untreated and magnetically conditioned seawater samples were measured by the Wilhelmy plate method, with both samples tested for contact angle against a standard polytetrafluoroethylene (PTFE) hydrophobic reference surface, in order to determine the fraction of the overall surface tension of each sample making up their non-polar surface tensions. Such results are shown in Table I.

TABLE I
Surface Tensions and Contact Angles on PTFE
Untreated and Magnetically Conditioned Sea Water

| | Untreated | Conditioned | Untreated | Conditioned |
|---|---|---|---|---|
| | Sea Water | Sea Water | Sea Water | Sea Water |
| | Surface | Surface | Contact | Contact |
| | Tension | Tension | Angle | Angle |
| Test # | (mN/m) | (mN/m) | (degrees) | (degrees) |
| 1 | 64.95 | 62.12 | 114.1 | 117.8 |
| 2 | 64.95 | 62.13 | 113.6 | 117.3 |
| 3 | 64.96 | 62.17 | 114.5 | 117.3 |
| 4 | 64.98 | 62.12 | 114.2 | 117.3 |
| 5 | 64.98 | 62.12 | 113.5 | 117.8 |
| Average | 64.96 | 62.13 | 114.0 | 117.5 |
| Std. | 0.01 | 0.02 | 0.4 | 0.3 |
| Dev. | | | | |

Reducing the overall surface tension of seawater and increasing its surface polarity makes seawater more hydrophilic. The overall surface tension of untreated seawater (64.96 MilliNewtons per meter, or mN/M) is quite a bit lower than that of pure distilled water (72.5 mN/m), and its surface polarity (68.25%) is a bit higher than that of pure distilled water (63.4%). Seawater contains both surface active impurities in the form of proteins and other organics from sea life that lower overall surface tension, as well as polarity building impurities in the form of salts that increase the surface polarity of seawater.

Untreated seawater had an overall surface tension of 64.96 mN/M, dispersive surface tension of 20.62 mN/M, polar surface tension of 44.34 mN/M and surface polarity of 68.25%; magnetically conditioned seawater had an overall surface tension of 62.13 mN/M, dispersive surface tension of 15.53 mN/M, polar surface tension of 46.60 mN/M and surface polarity of 75.00%. Such results are shown in Table II.

TABLE II
Untreated and Magnetically Conditioned Seawater
(Flowing through Magnet)

| | Overall | Dispersive | Polar | |
|---|---|---|---|---|
| | Surface | Surface | Surface | Surface |
| | Tension | Tension | Tension | Polarity |
| | (mN/m) | (mN/m) | (mN/m) | (%) |
| Untreated | 64.96 | 20.62 | 44.34 | 68.25 |
| Sea Water | | | | |
| Conditioned | 62.13 | 15.53 | 46.60 | 75.00 |
| Sea Water | | | | |

Interfacial tension is normally moderately high between oil and water, and the two liquids are immiscible because the hydrogen bonding structure of water discourages interaction with the oil. As disclosed herein, experimentation has shown that directing a first fluid mixture containing at least one polar substance, (e.g., seawater) and at least one dissimilar material (e.g., motor oil) through a magnetically conductive conduit having magnetic energy directed along the longitudinal axis of the magnetically energized conduit and extending through at least a portion of the first fluid mixture provides a conditioned fluid medium, wherein the at least one dissimilar material separates from the conditioned fluid medium at an increased rate as compared to a rate of separation of the at least one dissimilar material from the first fluid mixture.

The pendant drop method was utilized to analyze the interfacial tensions of seawater against motor oil. A drop of seawater having minerals and salts dissolved in the water to be studied for interfacial tension was formed to about 90% of its detachment volume on the end of a downward-pointing capillary tip, within a bulk phase of the motor oil. The drop was then digitally imaged using a high pixel camera, and analyzed to determine the drop's mean curvature at over 300 points along its surface.

The curvature of the drop that is pendant to the capillary tip, at any given point on its interface with the continuous phase, is dependent on two opposing factors, or forces. Interfacial tension works to keep the drop spherical while gravity works to make the drop elongated or “drip-like”; and the greater the difference in density between the drop of liquid and the continuous phase, the greater this force. Pendant drop evaluation involves observing the balance that exists between gravity and interfacial tension in the form of the drop's mean curvature at various points along its interface with the continuous phase. Lower interfacial tension liquids form a more “drip-like” shape while higher interfacial tension liquids form a more spherical drop shape. The actual mathematics of pendant drop analysis are based on the Laplace equation that says pressure differences exist across curved surfaces. The measurement of interfacial tension is actually made by determining the mean curvature of a drop at over 300 points, with the points then used in pairs in equations to solve for interfacial tension at least 150 times on any given drop; with those interfacial tension values then being averaged to give a single value for the overall interfacial tension of the drop.

This technique requires known values for the densities of all liquids involved in the studies at the conditions of interest, i.e. temperature. Such densities were determined prior to each set of pendant drop experiments by weighing precise volumes of each liquid phase having an identical temperature. The density of seawater was determined to be 1.003 g/cm³ and the density of motor oil was determined to be 0.8423 g/cm³. Using those densities, and as shown in Table III, the following interfacial tensions were determined for the treated and untreated samples.

TABLE III
Interfacial Tensions between Motor Oil and Sea Water

| | Untreated Motor Oil/ | Conditioned Motor Oil/Sea |
|---|---|---|
| | Seawater | Water |
| Test # | Interfacial Tension (mN/m) | Interfacial Tension (mN/m) |
| 1 | 28.36 | 33.14 |
| 2 | 28.33 | 33.05 |
| 3 | 28.39 | 33.10 |
| 4 | 28.42 | 33.14 |
| 5 | 28.42 | 33.08 |
| Average | 28.38 | 33.10 |
| Std. Dev. | 0.03 | 0.04 |

The interfacial tension of untreated seawater and motor oil was determined to be 28.38 mN/M. The interfacial tension of the magnetically conditioned seawater and motor oil was determined to be 33.10 mN/M. The higher interfacial tension of the conditioned motor oil/sea water indicates magnetic conditioning has an emulsion-breaking effect thereby improving oil/water separation.

The presently claimed and/or disclosed inventive concepts include a method of increasing the rate by which a dissimilar material separates in a fluid mixture, including the steps of passing a first fluid mixture containing at least one polar substance and at least one dissimilar material through a magnetically conductive conduit having magnetic energy directed along the longitudinal axis of the magnetically energized conduit and extending through at least a portion of the first fluid mixture thereby providing a conditioned fluid medium; and separating the conditioned fluid medium into at least two distinct phases in a separation apparatus downstream of the magnetically conductive conduit, wherein the at least one dissimilar material separates from the conditioned fluid medium at an increased rate as compared to a rate of separation of the at least one dissimilar material from the first fluid mixture.

The presently claimed and/or disclosed inventive concepts may further include the step of recovering the first fluid mixture from the conditioned fluid medium, wherein the first fluid mixture has a reduced volume of the at least one dissimilar material and the step of recovering the at least one dissimilar material from the conditioned fluid medium, wherein the at least one dissimilar material has a reduced volume of the first fluid mixture. The at least one dissimilar material may be selected from the group consisting of hydrocarbon compounds, autotrophic organisms, chemical compounds, solids, fats, and combinations thereof. The viscosity of the conditioned fluid medium may be lower than the viscosity of the first fluid mixture. A particle size of the at least one dissimilar material in the conditioned fluid medium may be larger than a particle size of the at least one dissimilar material in the first fluid mixture. The first fluid mixture may be heated upstream of the magnetically conductive conduit. The conditioned fluid medium may be heated upstream of the separation apparatus and/or within the separation apparatus. At least one chemical compound may be dispersed in the first fluid mixture. At least one chemical compound may be dispersed in the conditioned fluid medium. At least one polar substance may be water having a viscosity less than 1 centipoise at 20° C.

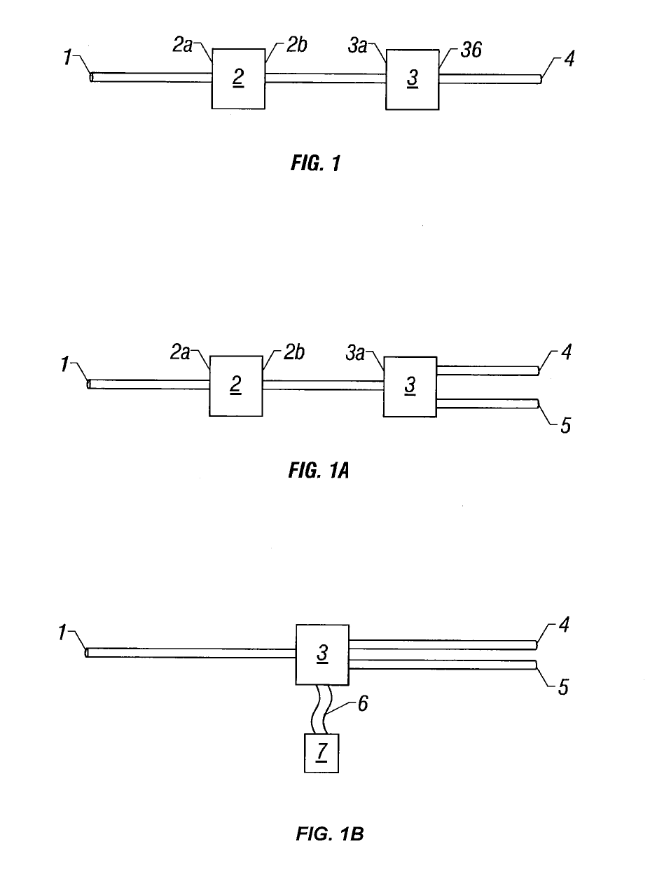

FIG. 1 is a schematic diagram of an embodiment of the presently claimed and/or disclosed inventive concepts for phase separation wherein a magnetically conductive conduit 2 is shown coupled to a separation apparatus 3 for fluid flow there between. A fluid mixture containing at least one polar substance and at least one dissimilar material introduced to port 1 may be directed to pass through fluid entry port 2a at the proximal end of the magnetically conductive conduit before passing through magnetically conductive conduit 2 having magnetic energy directed along the longitudinal axis of a magnetically energized conduit. The fluid may then be discharged from fluid discharge port 2b at the distal end of the magnetically conductive conduit as a conditioned fluid medium. The conditioned fluid medium may then be directed through inlet port 3a of separation apparatus 3 having a capacity to separate the at least one dissimilar material from the conditioned fluid medium and retaining a volume of the at least one dissimilar material within the fluid impervious boundary wall of the separation apparatus, then directed to pass through outlet port 3b of the separation apparatus before being discharged as an amount of the conditioned fluid medium containing a reduced volume of the at least one dissimilar material through port 4.

Sediment, dirt, oil, and water that accumulate at the bottom of oilfield collection vessels and storage tanks in refineries reduce the storage capacity of such vessels and tanks. Oily sludge forms an amalgamated mixture periodically cleaned from such vessels and processed to recover distinct hydrocarbon, solids and water phases.

Oil sands are a type of unconventional petroleum deposit having naturally occurring mixtures of sand saturated with a form of petroleum technically referred to as bitumen that flows very slowly. Oil sands may be extracted for processing by strip mining, or the oil may be made to flow into wells by in-situ techniques such as cyclic steam stimulation, steam assisted gravity drainage, solvent extraction, vapor extraction or toe to heel processes which reduce oil viscosity by injecting steam, solvents and/or hot air into the sands. These processes can use large quantities of water that are typically blended with the hydrocarbons and solids of the oil sands to form an amalgamated mixture. Significant amounts of energy are then required to extract hydrocarbons from the amalgamated mixture and process the water and solids for disposal and/or reuse.

The presently claimed and/or disclosed inventive concepts include a method for performing phase separation, including the steps of passing an amount of a fluid mixture containing at least one polar substance through a magnetically conductive conduit having magnetic energy directed along the longitudinal axis of the magnetically energized conduit and extending through at least a portion of the first fluid mixture thereby providing a conditioned fluid medium; blending at least one solid material and at least one hydrocarbon material with an amount of the conditioned fluid medium to form an amalgamated mixture; and separating a hydrocarbon phase, a solid phase, and a conditioned fluid medium phase from said amalgamated mixture, wherein at least one of the solid material phase and the hydrocarbon material phase separates from the conditioned fluid medium at an increased rate as compared to a rate of separation of at least one of the solid material phase and the hydrocarbon material phase from the first fluid mixture.

The presently claimed and/or disclosed inventive concepts may further include the step of recovering the hydrocarbon phase, wherein the hydrocarbon phase has a reduced volume of the solid phase and the conditioned fluid medium phase; the step of recovering the solid phase, wherein the solid phase has a reduced volume of the hydrocarbon phase and the conditioned fluid medium phase and the step of recovering the conditioned fluid medium phase, wherein the conditioned fluid medium phase has a reduced volume of the solid phase and the hydrocarbon phase.

The first fluid mixture may be heated upstream of a magnetically conductive conduit. The amalgamated mixture may be heated upstream of a separation apparatus and/or within a separation apparatus. At least one chemical compound may be dispersed in the fluid mixture. At least one chemical compound may be dispersed in the conditioned fluid medium. At least one chemical compound may be dispersed in the amalgamated mixture. The viscosity of the conditioned fluid medium may be lower than the viscosity of the fluid mixture. A particle size of at least one material of the amalgamated mixture may be larger than a particle size of at least one of the solid material and the hydrocarbon material. The at least one polar substance may be water having a viscosity less than 1 centipoise at 20° C.

The presently claimed and/or disclosed inventive concepts include a method for performing phase separation, including the steps of blending an amount of a first fluid mixture containing at least one polar substance with at least one solid material and at least one hydrocarbon material to form an amalgamated mixture; passing an amount of the amalgamated mixture through a magnetically conductive conduit having magnetic energy directed along the longitudinal axis of the magnetically energized conduit and extending through at least a portion of the amalgamated mixture thereby providing a conditioned amalgamated medium; and separating a hydrocarbon phase, a solid phase, and a conditioned fluid medium phase from the conditioned amalgamated medium, wherein at least one phase separates from the conditioned amalgamated medium at an increased rate as compared to a rate of separation of the at least one phase from the amalgamated mixture. The presently claimed and/or disclosed inventive concepts may further include the step of recovering the hydrocarbon phase, wherein the hydrocarbon phase has a reduced volume of the solid phase and the conditioned fluid medium phase; the step of recovering the solid phase, wherein the solid phase has a reduced volume of the hydrocarbon phase and the conditioned fluid medium phase; and the step of recovering the conditioned fluid medium phase, wherein the conditioned fluid medium phase has a reduced volume of the solid phase and the hydrocarbon phase.

The amalgamated mixture may be heated upstream of a magnetically conductive conduit. The conditioned amalgamated medium may be heated upstream of a separation apparatus and/or within a separation apparatus. At least one chemical compound may be dispersed in the first fluid mixture. At least one chemical compound may be dispersed in the amalgamated mixture. At least one chemical compound may be dispersed in the amalgamated medium. The viscosity of the conditioned fluid medium phase may be lower than the viscosity of the first fluid mixture. A particle size of at least one material of the conditioned amalgamated medium may be larger than a particle size of at least one of the solid material and the hydrocarbon material. The at least one polar substance may be water having a viscosity less than 1 centipoise at 20° C.

FIG. 1A is a schematic diagram of an embodiment of the presently claimed and/or disclosed inventive concepts for phase separation wherein magnetically conductive conduit 2 is shown coupled to separation apparatus 3 for fluid flow there between. A fluid mixture containing at least one polar substance and at least one dissimilar material introduced to port 1 may be directed to pass through fluid entry port 2a at the proximal end of the magnetically conductive conduit before passing through magnetically conductive conduit 2 having magnetic energy directed along the longitudinal axis of the magnetically energized conduit. The fluid may then be discharged from fluid discharge port 2b at the distal end of the magnetically conductive conduit as a conditioned fluid medium. The conditioned fluid medium may then be directed through inlet port 3a of separation apparatus 3 having a capacity to separate the at least one dissimilar material from the conditioned fluid medium. A first amount of the conditioned fluid medium having a reduced volume of the at least one dissimilar material may be discharged through outlet port 4 and the at least one dissimilar material containing a reduced volume of the conditioned fluid medium may be discharged through outlet port 5.

The presently claimed and/or disclosed inventive concepts include a method of separating at least one dissimilar material from a fluid mixture containing at least one polar substance, including the steps of establishing a flow of a first fluid mixture containing at least one polar substance and at least one dissimilar material through the magnetically conductive conduit having magnetic energy directed along the longitudinal axis of the magnetically energized conduit and extending through at least a portion of the first fluid mixture thereby providing a conditioned fluid medium; and directing a flow of at least a portion of the conditioned fluid medium through the separation apparatus. The first fluid mixture may be heated upstream of the magnetically conductive conduit. The conditioned fluid medium may be heated upstream of the separation apparatus and/or within the separation apparatus. At least one chemical compound may be dispersed in the first fluid mixture. At least one chemical compound may be dispersed in the conditioned fluid medium.

The presently claimed and disclosed inventive concepts of increasing the efficiency of phase separation of a dissimilar material from a first fluid mixture containing at least one polar substance were quantified in a second example. A closed loop system having a five gallon collection vessel, a 12 VDC diaphragm pump energized with a variable power supply, a flow meter and an embodiment of the presently claimed and disclosed magnetically conductive conduit connected with ½″ plastic tubing (with the tubing being made of a material that, in and of itself, would not affect any physical properties of a fluid mixture sample) was utilized to generate untreated and magnetically conditioned fluid samples, with the variable power supply providing an adjustable amount of electrical energy to energize the DC pump and control the fluid flow rate. The closed loop system allowed fluid to be pulled from collection vessel by the pump and propelled through the flow meter and magnetically conductive conduit before being returned to the collection vessel.

Three gallons of homogenized whole milk were decanted into the collection vessel. The pump was energized and power supply adjusted to circulate the milk through the system at a rate of 2.0 gallons per minute (gpm). After circulating the milk for 5 minutes to allow for the dismissal of any bubbles so that the milk was circulating at a steady-state flow, a first sample of untreated milk was collected in a first 2 liter graduated container. The output of electrical energy supplied to the DC pump was then adjusted to maintain a flow rate of 2.0 gpm through the closed loop system.

A coiled electrical conductor encircling the magnetically conductive conduit was then energized with 12 VDC and approximately 5 amps of electrical energy. A second sample of milk, directed to make only one pass through an area of magnetic conditioning concentrated along a path extending through the electrical conductor encircling the outer surface of the magnetically energized conduit generating approximately 1000 gauss (unit of magnetic field measurement) of magnetic energy and approximately 150 gauss of magnetic energy concentrated at each end of the magnetically energized conduit, was collected in a second 2 liter graduated container. The output of electrical energy supplied to the DC pump was again adjusted to maintain a flow rate of 2.0 gpm through the closed loop system.

After circulating the milk through the magnetically energized conduit for 4 additional minutes, a third milk sample directed to make approximately six passes through the concentrated magnetic energy was collected in a third 2 liter graduated container. The output of electrical energy supplying the DC pump was again adjusted to maintain a flow rate of 2.0 gpm through the system. After circulating the milk for an additional 26 minutes through magnetically energized conduit, a fourth milk sample directed to make approximately 30 passes through the concentrated magnetic energy was collected in a fourth 2 liter graduated container.

The collected samples were allowed to rest at room temperature for 24 hours to observe any gravity separation of phases of the homogenized whole milk. After 24 hours, the first (untreated) sample showed no signs of separation and appeared to remain in a homogenized state. Approximately 75 ml of at least one dissimilar material was observed floating at the top of the second milk sample. Approximately 225 ml of at least one dissimilar material was observed floating at the top of the third milk sample. Approximately 400 ml of at least one dissimilar material was observed resting beneath the fourth milk sample. As disclosed herein, magnetic conditioning of homogenized whole milk and gravity separation at ambient temperature resulted in at least one dissimilar material separating from each sample of magnetically conditioned milk at an increased rate as compared to a rate of separation of the at least one dissimilar material from untreated milk. Such results are shown in Table IV.

TABLE IV
Untreated and Magnetically Conditioned Whole Milk
(Flowing through Magnet)

| | | | Magnetically | |
|---|---|---|---|---|
| | | Magnetically | Conditioned | Magnetically |
| | Untreated | Conditioned | Milk - | Conditioned |
| | Milk | Milk - 1 Pass | 6 Passes | Milk - 30 Passes |
| % Separation | 0.00% | 3.75% | 11.25% | 20.00% |

The presently claimed and disclosed inventive concepts of increasing the efficiency of phase separation of a dissimilar material from a first fluid mixture containing at least one polar substance were quantified in a third example. A closed loop system having a 2 gallon collection vessel, a centrifugal pump operating at a flow rate of 4 gpm, and an embodiment of the presently claimed and disclosed magnetically conductive conduit were connected with ½″ plastic tubing to generate untreated and magnetically conditioned fluid samples. The closed loop system allowed fluid to be pulled from the collection vessel by the pump and propelled through the magnetically conductive conduit before being returned to the collection vessel.

A first sample was generated by decanting 500 ml of high mineral containing whey such as Greek yogurt whey containing suspended solids, such as lactose, calcium, magnesium, lactates and other minerals. The pump was energized and adjusted to circulate the whey through the system at a rate of 1.0 gallon per minute (gpm). After circulating the untreated whey containing minerals for 2 minutes to allow for the dismissal of any bubbles so that it was circulating at a steady-state flow, a first sample of untreated whey was collected in a first 1 liter separatory funnel. The coiled electrical conductor encircling the magnetically conductive conduit was not energized during the generation of the first whey sample.

A second sample was generated by decanting 500 ml of untreated whey containing minerals into the collection vessel, circulating the untreated whey for 2 minutes to achieve steady-state flow and then energizing the coiled electrical conductor encircling the magnetically conductive conduit with approximately 32 VDC and 10 amps of electrical energy, with the energized conduit configured to induce a negative polarity to fluid flowing through the conduit. The whey was then directed to make 10 passes through areas of magnetic conditioning concentrated along a path extending through the magnetically energized conduit. Approximately 3,300 gauss of magnetic energy was concentrated near the center of the magnetically energized conduit and approximately 1,000 gauss of magnetic energy was concentrated at each end of the conduit. The second sample of negatively conditioned whey containing minerals was collected in a second 1 liter Separatory funnel. Approximately 30 minutes elapsed between the generation of the first sample and the second sample.

After purging any negatively charged whey from the closed-loop and rinsing the system, a third sample was generated by decanting 500 ml of untreated whey containing minerals into the collection vessel and circulating the untreated whey for 2 minutes to achieve steady-state flow. Prior to energizing the magnetically energized conduit, the polarity induced by the magnetically energized conduit was reversed. The whey was then directing to make 10 passes through the magnetically energized conduit inducing a positive polarity. The third sample of negatively conditioned whey containing minerals was collected in a third 1 liter Separatory funnel. Approximately 30 minutes elapsed between the generation of the second sample and the third sample.

The pH of each sample was adjusted to ˜7.2 using sodium hydroxide and then the samples were heated to ˜80 degrees C. Gravity separation of minerals from the untreated whey (control) and magnetically conditioned samples was observed for 1 hour. Approximately 200 ml of minerals settled to the bottom of the separatory funnel containing the first (untreated) sample, approximately 180 ml of minerals settled to the bottom of the separatory funnel containing the second (negatively conditioned) sample, and approximately 180 ml of minerals settled to the bottom of the separatory funnel containing the third (positively conditioned) sample. The samples were then directed through a filtration apparatus.

Using the equation Yield (%)=([(% suspended solids) sub Bottom×([weight)] sub Bottom)/([(% suspended solids) sub feed×([weight)] sub feed)×100, the negatively conditioned sample and the positively conditioned sample were found to each contain approximately 50% more minerals content than the untreated (control) sample as each sample flowed through the filtration apparatus. Such results are shown in Table IX.

TABLE IX
Untreated and Magnetically Greek Whey (Flowing through Magnet)

| | Untreated | | |
|---|---|---|---|
| | Whey | Negatively | Positively |
| | Circulated to | Conditioned Whey | Conditioned Whey |
| | Steady-State | x Passes | x Passes |
| % Separation | 40% | 59% | 58% |
| of Minerals | | | |

The presently claimed and/or disclosed inventive concepts include a method of increasing the efficiency of phase separation of a dissimilar material from a first fluid mixture containing at least one polar substance at ambient temperature, including the step of installing a magnetically conductive conduit having magnetic energy directed along the longitudinal axis of the magnetically energized conduit upstream of an inlet of a separation apparatus thereby providing a conditioned fluid medium entering the inlet of the separation apparatus, wherein the at least one dissimilar material separates from the conditioned fluid medium at an increased rate as compared to a rate of separation of the at least one dissimilar material from the first fluid mixture.

FIG. 1B schematically depicts an embodiment of the presently claimed and/or disclosed inventive concepts for increasing the efficiency of phase separation of a dissimilar material from a fluid mixture containing at least one polar substance wherein a magnetically conductive conduit is disposed within separation apparatus 3 and includes the steps of establishing a flow of a first fluid mixture containing at least one polar substance and at least one dissimilar material through an inlet port of a separation apparatus having a capacity to separate the at least one dissimilar material from a conditioned fluid medium, the separation apparatus having a fluid impervious boundary wall having an inner surface, the inlet port for receiving a fluid mixture, a first outlet port for discharging a first amount of the conditioned fluid medium having a reduced volume of the at least one dissimilar material and a second outlet port for discharging the at least one dissimilar material containing a reduced volume of the conditioned fluid medium; directing the first fluid mixture to pass through a magnetically conductive conduit disposed downstream of the inlet port and within the inner surface of the fluid impervious wall of the separation apparatus, the magnetically conductive conduit having magnetic energy directed along the longitudinal axis of the magnetically energized conduit and extending through at least a portion of the first fluid mixture thereby providing a conditioned fluid medium; and directing a flow of at least a portion of the conditioned fluid medium through the separation apparatus, wherein the at least one dissimilar material separates from the conditioned fluid medium at an increased rate as compared to a rate of separation of the at least one dissimilar material from the first fluid mixture.

At least one electrical power supply 7 is shown operably connected to at least one of the first and second conductor leads 6 of the magnetically conductive conduit disposed within the separation apparatus 3. Heat produced by the magnetically energized conduit may radiate into the conditioned fluid medium to increase the rate of phase separation. An amount of the conditioned fluid medium having a reduced volume of the at least one dissimilar material may then be discharged from first outlet port 4 and at least one dissimilar material containing a reduced volume of the conditioned fluid medium may then be discharged from second outlet port 5. At least one chemical compound may be dispersed in the first fluid mixture. At least one chemical compound may be dispersed in the conditioned fluid medium.

In each embodiment of the presently claimed and/or disclosed inventive concepts for separating at least one dissimilar material from a fluid mixture containing at least one polar substance and performing phase separation, it can be appreciated that magnetic energy may be concentrated in a plurality of distinct areas along the longitudinal axis of the magnetically energized conduit.

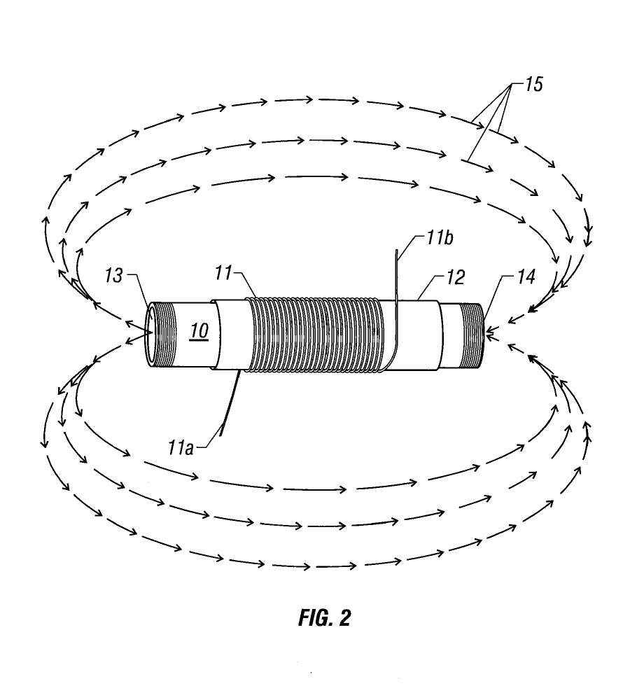

FIG. 2 shows a flow of magnetic flux loops 15 generated by energized coil 11. Coil core 12 is shown sleeving a section of magnetically conductive conduit 10 wherein the coiled electrical conductor 11 encircling the coil core 12 sleeves at least a section of an outer surface of the magnetically conductive conduit with at least one turn of the electrical conductor oriented substantially orthogonal to the longitudinal axis of the conduit. A single length of electrical conducting material is shown forming coil 11.

Operably connecting first conductor lead 11a and second conductor lead 11b to at least one supply of electrical power energizes the coiled electrical conductor and produce an electromagnetic field absorbed by magnetically conductive conduit 10 and concentrated within the inner surface of the fluid impervious boundary wall of the conduit. Magnetic flux loops 15 are shown consolidated at a point beyond port 13 at the proximal end of magnetically energized conduit 10, flowing around the periphery of continuous coil 11 along the longitudinal axis of the conduit and reconsolidating at a point beyond port 14 at the distal end of the magnetically energized conduit. Fluid directed to pass through the magnetically energized conduit may receive magnetic conditioning in at least one region along the fluid flow path extending through magnetically energized conduit 10. Magnetically conductive coupling devices and/or conduits and non-magnetically conductive coupling devices and/or conduits may be utilized to make fluid impervious connections with inlet port 13 and outlet port 14 of magnetically energized conduit 10 to promote the flow of fluid through magnetic energy.

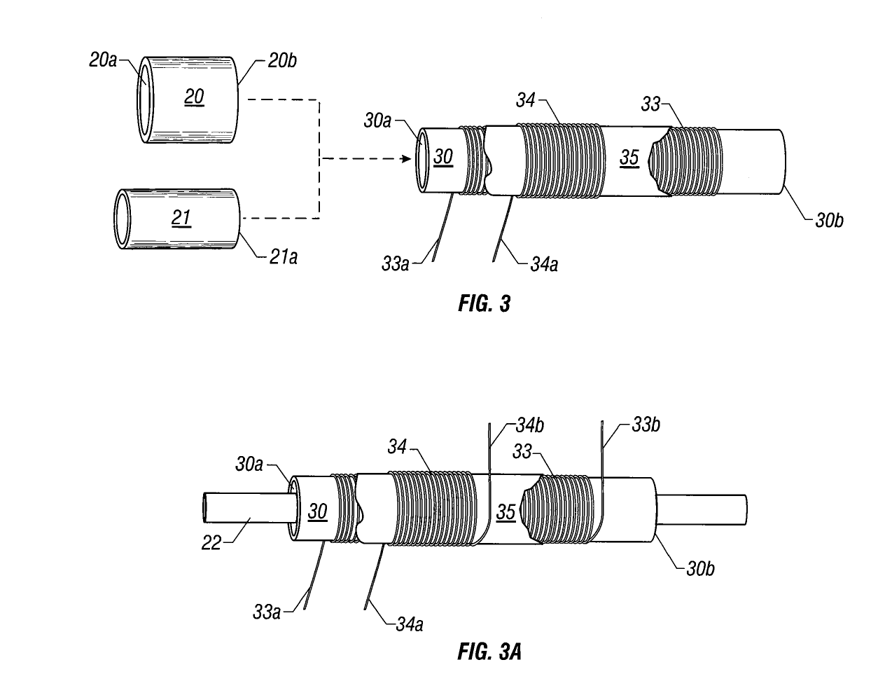

FIG. 3 schematically depicts an embodiment of the magnetically conductive conduit having a length of magnetically conductive material 30 defining a fluid impervious boundary wall with an inner surface and an outer surface and having port 30a at the proximal end of the conduit and port 30b at the distal end of the conduit. The inner surface of the boundary wall of magnetically conductive conduit 30 establishes a fluid flow path extending along the longitudinal axis of the conduit. A single length of electrical conducting material is shown forming first coil layer 33 and second layer 34 encircling the outer surface of magnetically conductive conduit 30 wherein the coiled electrical conductor sleeves at least a section of an outer surface of the magnetically conductive conduit with at least one turn of the electrical conductor oriented substantially orthogonal to the fluid flow path extending through the conduit.

Non-magnetic stabilizer 35 is shown disposed between the coil layers. Conductor leads 33a and 34a may be operably connected to at least one electrical power supply to energize the coiled electrical conductor and establish a magnetic field having lines of flux directed along the flow path of the fluid. Introducing a fluid mixture containing at least one polar substance to port 30a may direct the fluid to pass through at least one area of magnetic energy concentrated along a path extending through at least one turn of electrical conducting material encircling the outer surface of magnetically conductive conduit 30.

Coupling segment 20 is an embodiment of a non-magnetically conductive fluid flow conduit utilized to promote a flow of fluid through magnetically conductive conduit 30, said coupling segment having a non-magnetically conductive material defining a fluid impervious boundary wall with an inner surface and an outer surface and having inlet port 20a and outlet port 20b. Outlet port 20b may be adapted to provide for the fluid impervious connection with port 30a of magnetically conductive conduit 30, and inlet port 20a may be adapted to provide for the fluid impervious, non-contiguous connection of magnetically conductive conduit 30 with an additional segment of conduit, said non-contiguous connection establishing a non-magnetically conductive region providing for a concentration of magnetic energy at port 30a of conduit 30.

The non-contiguous connection between the magnetically conductive conduit 30 and an additional segment of magnetically conductive conduit establishes a non-magnetically conductive region providing for an increased concentration of magnetic energy in the space between the magnetically conductive conduits. An additional non-magnetically conductive coupling segment may similarly provide for the connection of port 30b of magnetically conductive conduit 30 with an additional segment of conduit to establish a non-magnetically conductive region providing for a concentration of magnetic energy at port 30b of magnetically conductive conduit 30.

Non-magnetically conductive conduit 21 is an embodiment of a non-magnetically conductive fluid flow conduit utilized to promote a flow of fluid through magnetically conductive conduit 30, said fluid flow conduit having a non-magnetically conductive material defining a fluid impervious boundary wall with an inner surface and an outer surface and having port 21a adapted to provide for the fluid impervious connection of fluid flow conduit 21 with port 30a of magnetically energized conduit 30, whereby said connection establishes a non-magnetically conductive region providing for a concentration of magnetic energy at port 30a of magnetically conductive conduit 30. An additional segment of non-magnetically conductive fluid flow conduit may similarly be adapted to provide a fluid impervious connection with port 30b of magnetically conductive conduit 30 to establish a non-magnetically conductive region providing for a concentration of magnetic energy at port 30b of magnetically conductive conduit 30.

FIG. 3A schematically depicts a first length of electrical conducting material forming coil layer 33 and a second length of electrical conducting material forming coil layer 34 encircling magnetically conductive conduit 30, wherein the coiled electrical conductor sleeves at least a section of an outer surface of magnetically conductive conduit 30 with at least one turn of the electrical conductor oriented substantially orthogonal to the fluid flow path extending through the conduit. Non-magnetic stabilizer 35 is shown disposed between the layers of electrical conducting material to maintain the alignment of the coaxially disposed coil layers.

First conductor lead 33a and second conductor lead 33b of the first coil layer and first conductor lead 34a and second conductor lead 34b of the second coil layer may be operably connected separately and/or in combination to at least one supply of electrical power, to energize the coils. The first and second conductor leads of the first length of electrical conducting material may be connected to a first at least one supply of electrical power and first and second conductor leads of the second length of electrical conducting material may be connected to a second at least one supply of electrical power to energize the coils.

Fluid flow conduit 22 is an embodiment of a non-magnetically conductive fluid flow conduit utilized to promote a flow of fluid through magnetically conductive conduit 30, said fluid flow conduit defining a section of conduit within a piping system having a non-magnetically conductive material sleeved within magnetically conductive conduit 30, the fluid flow conduit being made with a length of non-magnetically conductive material defining a fluid impervious boundary wall with an inner surface and an outer surface and having inlet and outlet ports. Introducing a fluid mixture containing at least one polar substance to the inlet of conduit 22 may direct fluid to pass through a first area of magnetic conditioning concentrated at port 30a at the proximal end of magnetically energized conduit 30, a second area of magnetic conditioning concentrated along a path extending through at least one turn of electrical conducting material encircling the outer surface of magnetically conductive conduit 30 and a third area of magnetic conditioning concentrated at port 30b at the distal end of magnetically energized conduit 30.

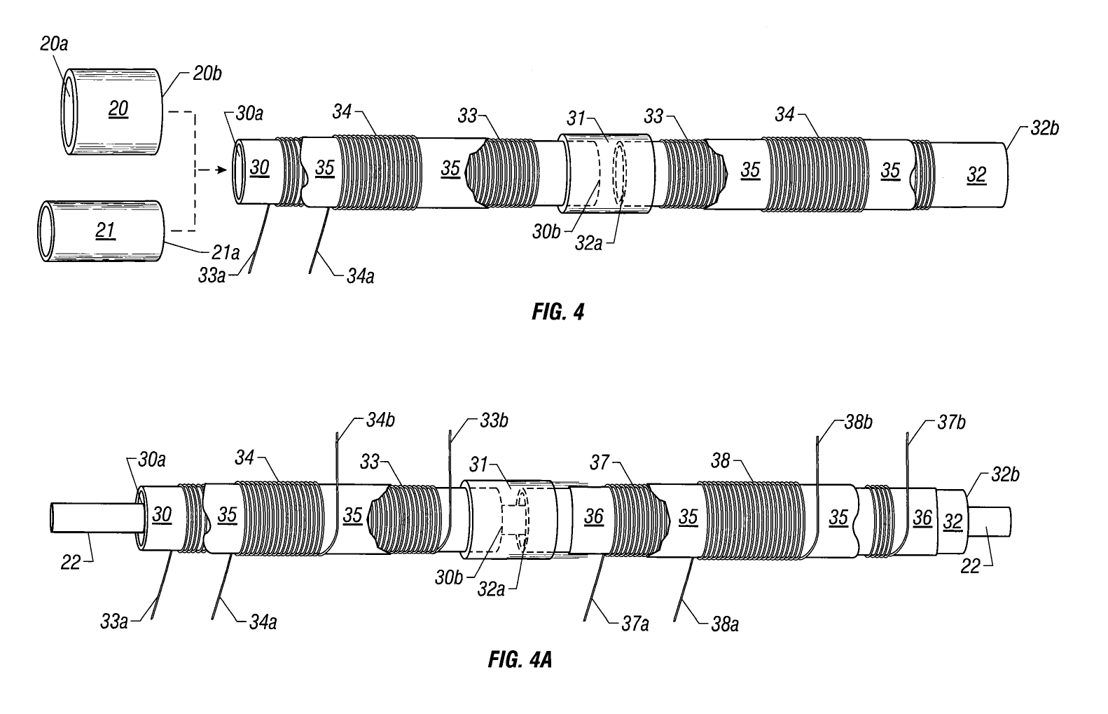

FIG. 4 schematically depicts an alternate embodiment of the magnetically conductive conduit having more than one length of magnetically conductive material forming the magnetically conductive conduit. A serial coupling of a magnetically conductive inlet conduit segment, a non-magnetically conductive intermediate conduit segment and a magnetically conductive outlet conduit segment may form the magnetically conductive conduit, each conduit segment having a length of material defining a fluid impervious boundary wall with an inner surface and an outer surface and having a port at the proximal end of the conduit segment and a port at the distal end of the conduit segment.

The serial coupling of magnetically conductive inlet conduit segment 30, non-magnetically conductive intermediate conduit segment 31 and magnetically conductive outlet conduit segment 32 establishes a non-magnetically conductive region between the magnetically conductive conduit segments that provides for a concentration of magnetic energy in the area between distal port 30b of magnetically conductive inlet conduit segment 30 and proximal port 32a of magnetically conductive outlet conduit segment 32. A single length of electrical conducting material is shown forming first coil layer 33 and second coil layer 34 encircling magnetically conductive inlet conduit segment 30, non-magnetically conductive intermediate conduit segment 31 and magnetically conductive outlet conduit segment 32, wherein the coiled electrical conductor sleeves at least a section of an outer surface of a magnetically conductive conduit segment with at least one turn of the electrical conductor oriented substantially orthogonal to the fluid flow path extending through the magnetically conductive conduit. Non-magnetic stabilizer 35 is shown disposed between the coil layers to maintain the alignment of the coaxially disposed coil layers. First conductor lead 33a and second conductor lead 34a may be operably connected to at least one supply of electrical power to energize the coiled electrical conductor and establish a magnetic field having lines of flux directed along the flow path of the fluid. Introducing a fluid mixture containing at least one polar substance to port 30a may direct a flow of the fluid to pass through a first area of magnetic conditioning concentrated at port 30a at the proximal end of the magnetically energized conduit. The flow may then pass through a second area of magnetic conditioning concentrated along a path extending through at least one turn of the coiled electrical conductor encircling the outer surface of magnetically energized inlet conduit segment 30 and a third area of magnetic conditioning concentrated in the space between port 30b at the distal end of magnetically energized inlet conduit segment 30 and port 32a at the proximal end of magnetically energized outlet conduit segment 32. The fluid may then pass through a fourth area of magnetic conditioning concentrated along a path extending through at least one turn of the coiled electrical conductor encircling the outer surface of magnetically energized outlet conduit segment 32 and a fifth area of magnetic conditioning concentrated at port 32b at the distal end of the magnetically energized conduit.

Coupling segment 20 is an embodiment of a non-magnetically conductive fluid flow conduit utilized to promote a flow of fluid through the magnetically conductive conduit, said coupling segment including a non-magnetically conductive material defining a fluid impervious boundary wall with an inner surface and an outer surface and having inlet port 20a and outlet port 20b. Outlet port 20b may be adapted to provide for the fluid impervious connection with port 30a of magnetically energized inlet conduit segment 30 and inlet port 20a may be adapted to provide for the fluid impervious, non-contiguous connection of the magnetically energized conduit with an additional segment of conduit, said non-contiguous connection establishing a non-magnetically conductive region providing for a concentration of magnetic energy at port 30a of the magnetically energized conduit.

The non-contiguous connection between magnetically energized inlet conduit segment 30 and an additional segment of magnetically conductive conduit establishes a non-magnetically conductive region providing for an increased concentration of magnetic energy in the space between the magnetically conductive conduits. An additional non-magnetically conductive coupling segment may similarly provide for the connection of port 32b of magnetically conductive outlet conduit segment 32 with an additional segment of conduit to establish a non-magnetically conductive region providing for a concentration of magnetic energy at port 32b of the magnetically energized conduit.

Non-magnetically conductive conduit 21 is an embodiment of a non-magnetically conductive fluid flow conduit utilized to promote a flow of fluid through the magnetically conductive conduit, said fluid flow conduit including a non-magnetically conductive material defining a fluid impervious boundary wall with an inner surface and an outer surface and having port 21a adapted to provide for the fluid impervious connection of said fluid flow conduit with port 30a of magnetically energized inlet conduit segment 30, whereby said connection establishes a non-magnetically conductive region providing for a concentration of magnetic energy at port 30a of the magnetically energized conduit. An additional segment of non-magnetically conductive fluid flow conduit may similarly be adapted to provide a fluid impervious connection with port 32b of the magnetically energized outlet conduit segment to establish a non-magnetically conductive region providing for a concentration of magnetic energy at port 32b of the magnetically energized conduit.

FIG. 4A schematically depicts an alternate embodiment of the magnetically conductive conduit having more than one length of magnetically conductive material forming the magnetically conductive conduit wherein the inner surfaces of the boundary walls of the serial coupling of conduit segments establish a flow path extending along the longitudinal axis of the magnetically conductive conduit.

A first length of electrical conducting material forming first coil layer 33 having conductor leads 33a and 33b is shown encircling magnetically conductive inlet conduit segment 30, a second length of electrical conducting material forming second coil layer 34 having conductor leads 34a and 34b is shown encircling coil layer 33, a third length of electrical conducting material forming a first coil layer 37 having conductor leads 37a and 37b is shown encircling coil core 36 and a fourth length of electrical conducting material forming second coil layer 38 having conductor leads 38a and 38b is shown encircling coil layer 37, wherein the coiled electrical conductors sleeve at least a section of an outer surface of a magnetically conductive conduit segment with at least one turn of the electrical conductor oriented substantially orthogonal to the fluid flow path extending through the magnetically conductive conduit. Non-magnetic stabilizer 35 is shown disposed between the layers of coiled electrical conducting material to maintain the alignment of the layers.

Coil core 36 is shown sleeving magnetically conductive outlet conduit segment 32, said coil core having a tubular conduit defining a boundary wall with an inner surface and an outer surface and having a port at the proximal end of the tube and a port at the distal end of the tube, the outer surface of said boundary wall adapted to receive the coiled electrical conductor and the ports at each end of the tube and the inner surface of said boundary wall adapted to sleeve at least a section of the magnetically conductive conduit, whereby at least a section of the inner surface of the boundary wall of said coil core is coaxially disposed in substantially concentric surrounding relation to at least a section of the outer surface of the boundary wall of the magnetically conductive conduit. The coil core may be made with a length of magnetically conductive conduit, or a coil core may be made with a non-magnetically conductive material, such as a film of non-magnetic stabilizing material or a non-magnetically conductive tube. As used herein, encircling the magnetically conductive conduit within at least one coiled electrical conductor, wherein at least one coiled electrical conductor sleeves at least a section of an outer surface of the magnetically conductive conduit with at least one turn of the electrical conductor oriented substantially orthogonal to the fluid flow path extending through the conduit may include coiling at least one electrical conductor around at least a section of the outer surface of the fluid impervious boundary wall of the magnetically conductive conduit or coiling at least one electrical conductor around at least a section of the outer surface of the boundary wall of a coil core and sleeving at least a section of the magnetically conductive conduit within the coil core.

Conductor leads 33a and 33b, 34a and 34b, 37a and 37b and 38a and 38b may be operably connected separately and/or in combination to at least one supply of electrical power. Energizing the coiled electrical conductor with at least one supply of electrical power produces an electromagnetic field conducted by the magnetically conductive inlet conduit segment and the magnetically conductive outlet conduit segment and concentrated within the inner surface of the fluid impervious boundary wall of each segment of magnetically conductive conduit, said magnetic field extending beyond each end of the magnetically conductive inlet conduit segment and magnetically conductive outlet conduit segment along the longitudinal axis of the magnetically energized conduit.

Fluid flow conduit 22 is an embodiment of a non-magnetically conductive fluid flow conduit utilized to establish a fluid flow path extending along the longitudinal axis of the magnetically conductive conduit, said fluid flow conduit defining a section of conduit within a piping system having a non-magnetically conductive material sleeved by magnetically conductive inlet conduit segment 30, non-magnetically conductive intermediate conduit segment 31 and magnetically conductive outlet conduit segment 32, said fluid flow conduit being made with a length of non-magnetically conductive material defining a fluid impervious boundary wall with an inner surface and an outer surface and having inlet and outlet ports.

Introducing a fluid mixture containing at least one polar substance to the inlet port of fluid flow conduit 22 may direct a fluid to pass through a first area of magnetic conditioning concentrated at port 30a at the proximal end of the magnetically energized conduit, a second area of magnetic conditioning concentrated along a path extending through at least one turn of electrical conductor encircling the outer surface of magnetically energized inlet conduit segment 30, a third area of magnetic conditioning concentrated within non-magnetically conductive conduit segment 31 in the space between port 30b at the distal end of the magnetically energized inlet conduit segment and port 32a at the proximal end of the magnetically energized outlet conduit segment, a fourth area of magnetic conditioning concentrated along a path extending through at least one turn of electrical conductor encircling the outer surface of magnetically energized outlet conduit segment 32 and a fifth area of magnetic conditioning concentrated at port 32b at the distal end of the magnetically energized conduit.

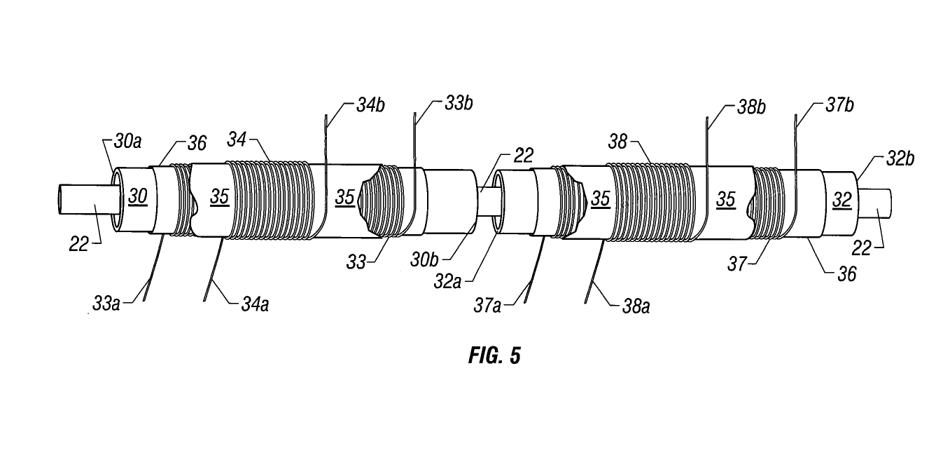

FIG. 5 schematically depicts an alternate embodiment of the magnetically conductive conduit having more than one length of magnetically conductive material forming the magnetically conductive conduit with a non-contiguous array of first magnetically conductive conduit 30 and second magnetically conductive conduit 32 forming the magnetically conductive conduit. Fluid flow conduit 22, made with a length of non-magnetically conductive material defining a fluid impervious boundary wall with an inner surface and an outer surface and having a fluid entry port at one end of the conduit and a fluid discharge port at the other end of the conduit, is shown extending through fluid entry port 30a at the proximal end of the magnetically conductive conduit, port 30b at a distal end of magnetically conductive conduit 30, port 32a at a proximal end of magnetically conductive conduit 32 and fluid discharge port 32b at a distal end of the magnetically conductive conduit to define a fluid flow path extending along the longitudinal axis of the magnetically conductive conduit.

A first length of an electrical conducting material having first conductor lead 33a and second conductor lead 33b forms first coil layer 33 encircling coil core 36, a second length of an electrical conducting material having first conductor lead 34a and second conductor lead 34b forms second coil layer 34 encircling coil layer 33, a third length of an electrical conducting material having first conductor lead 37a and second conductor lead 37b forms first coil layer 37 encircling coil core 36 and a fourth length of an electrical conducting material having first conductor lead 38a and second conductor lead 38b forms second coil layer 38 encircling coil layer 37, wherein each coiled electrical conductor sleeves at least a section of an outer surface of a length of magnetically conductive material forming the magnetically conductive conduit with at least one turn of the electrical conductor oriented substantially orthogonal to the fluid flow path extending through the conduit.

Coil core 36 is shown sleeving a section of the outer surface of magnetically conductive conduit 30 and coil core 36 is shown sleeving a section of the outer surface of magnetically conductive conduit 32. Non-magnetically conductive material 35 is shown disposed between the first and second layers of electrical conductors to maintain the alignment of the coil layers. At least one electrical power supply may be operably connected to at least one conductor lead to energize the coiled electrical conductors to produce a magnetic field having lines of flux directed along the fluid flow path. Fluid flowing through non-magnetically conductive fluid flow conduit 22 may be directed to pass through a first area of fluid conditioning at port 30a, a second area of magnetic conditioning along a path extending through and substantially orthogonal to each turn of the electrical conductors forming coils 33 and 34 encircling magnetically conductive conduit 30, a third area of magnetic conditioning in the space between port 30b and port 32a, a fourth area of magnetic conditioning along a path extending through and substantially orthogonal to each turn of the electrical conductors forming coils 37 and 38 encircling the outer surface of magnetically conductive conduit 32 and a fifth area of magnetic conditioning at port 32b.

Embodiments of the magnetically conductive conduit having a non-contiguous array of magnetically conductive conduits may be energized with at least one coil sleeving at least a section of a first magnetically conductive conduit, a non-magnetically conductive region between the magnetically conductive conduits and at least a section of a second magnetically conductive conduit.

The magnetically conductive conduit may be made of a sheet of magnetically conductive material rolled into at least one layer to form a tube defining a boundary wall with an inner surface and an outer surface and having a port at the proximal end of the tube and a port at the distal end of the tube. The inner and outer surfaces of the fluid impervious boundary wall of a magnetically conductive conduit may be covered with a protective coating to prevent corrosion and extend the functional life of the conduit. At least one end of a fluid impervious boundary wall of the magnetically conductive conduit may be tapered.

A non-magnetic stabilizing material may be disposed between the outer surface of a magnetically conductive conduit and the coiled electrical conductor, between the outer surface of a magnetically conductive conduit and the inner surface of a coil core, and/or between the outer surface of a coil core and the coiled electrical conductor. A non-magnetic stabilizing material may envelope the outer layer of a coiled electrical conductor to maintain the alignment of the coil and protect the electrical conducting material from cuts and abrasions.

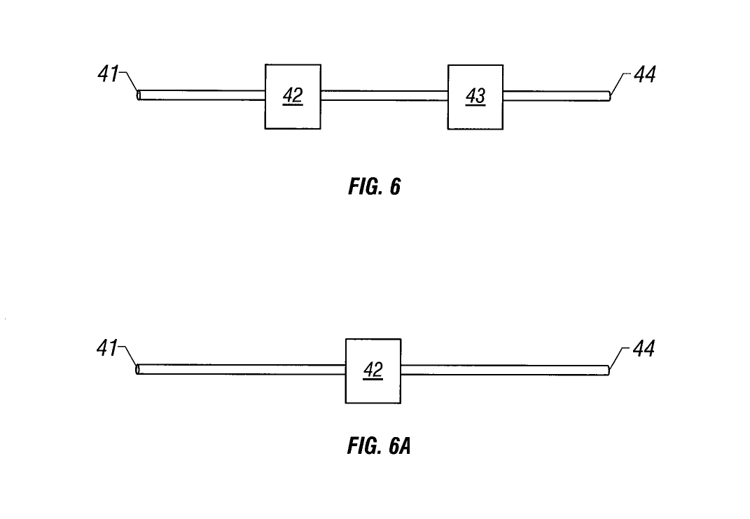

FIG. 6 schematically depicts an embodiment of the presently claimed and/or disclosed inventive concepts for altering a dispersive surface tension and a polar surface tension of a fluid to improve the mechanical blending of two or more distinct phases into a homogenous mixture. A fluid mixture containing at least one polar substance introduced to port 41 may be directed to pass through magnetically conductive conduit 42 having magnetic energy directed along the longitudinal axis of the magnetically energized conduit and extending through at least a portion of the fluid mixture, thereby altering a dispersive surface tension and a polar surface tension of a conditioned fluid medium. The conditioned fluid medium may then be directed through blending apparatus 43 where an amount of at least one dissimilar material may be dispersed into the conditioned fluid medium and blended into a homogenous mixture before being discharged from port 44 as a continuous mixture.

Utilizing the previously disclosed method of generating untreated and magnetically conditioned fluid samples, wherein a high throughput peristaltic pump (to prevent direct contact with the fluid samples) was used to propel the fluid samples through tubing (being made of a material that, in and of itself, would not affect any physical properties of a fluid mixture sample) sleeved by a non-energized magnetically conductive conduit and a magnetically energized conduit at a flow rate of 1150 ml/min; as disclosed herein, magnetic conditioning of a fluid mixture containing at least one polar substance was determined to alter a dispersive surface tension and a polar surface tension of the fluid and influence its interaction with other substances.

A first sample of untreated well water having concentrations of >300 ppm of calcium, magnesium, gypsum and other minerals was collected in a certified clean container after being directed to make only one pass through the length of non-energized magnetically conductive conduit. The sample flowed uncollected for approximately 30 to 45 seconds to allow for the dismissal of any bubbles so that the untreated well water sample was collected during steady-state flow.

A second sample of the well water was collected in a certified clean container after energizing a coiled electrical conductor encircling the conduit with 12 VDC and approximately 5 amps of electrical energy and directing the well water to make only one pass through a magnetically energized conduit having an area of magnetic conditioning concentrated along a path extending through at least one turn of the electrical conductor encircling the outer surface of the magnetically conductive conduit generating approximately 850 gauss (unit of magnetic field measurement) of magnetic energy, as well as approximately 150 gauss of magnetic energy concentrated at each end of the magnetically conductive conduit. The magnetically conditioned well water sample was similarly allowed to flow uncollected for approximately 30 to 45 seconds to allow for the dismissal of any bubbles so that the water sample was collected during steady-state flow.

Overall surface tensions of well water containing concentrations of >300 ppm of calcium, magnesium, gypsum and other minerals were measured on both untreated and magnetically conditioned water samples by the Wilhelmy plate method. Both samples were also tested for contact angle against a standard PTFE surface to determine the fraction of the overall surface tension of each sample making up their non-polar surface tensions. Untreated well water had an overall surface tension of 71.12 mN/M, dispersive surface tension of 26.35 mN/M, polar surface tension of 44.77 mN/M and surface polarity of 62.9%. Magnetically conditioned well water had an overall surface tension of 61.36 mN/M, dispersive surface tension of 17.43 mN/M, polar surface tension of 43.93 mN/M and surface polarity of 71.6%. Periodic monitoring indicated the changes in overall surface tension, dispersive surface tension, polar surface tension and surface polarity of the magnetically conditioned well water were greatest immediately after magnetic conditioning. Each property of the magnetically conditioned well water gradually returned to its untreated value after conditioning, with the magnetically conditioned well water returning to its untreated surface tension and surface polarity values after 48 hours. Such results are shown in Table V.

TABLE V
Component Surface Tension Information After Magnetic Conditioning
Well Water - (Flowing through Magnet)

| | Overall | Dispersive | Polar | |
|---|---|---|---|---|
| Time After | Surface | Surface | Surface | Surface |
| Conditioning | Tension | Tension | Tension | Polarity |
| (hours) | (mN/m) | (mN/m) | (mN/m) | (%) |
| 0 | 61.36 | 17.43 | 43.93 | 71.6 |
| 1 | 63.52 | 18.89 | 44.63 | 70.3 |
| 8 | 66.23 | 21.21 | 45.02 | 68.0 |
| 24 | 69.08 | 24.09 | 44.99 | 65.1 |
| 36 | 70.51 | 25.63 | 44.88 | 63.6 |
| 48 | 71.12 | 26.35 | 44.77 | 62.9 |

Reducing the surface tension of a fluid improves mechanical blending and allows at least one dissimilar material (such as a chemical compound) to be more readily dispersed and evenly distributed within a conditioned fluid medium (such as magnetically conditioned water). The presently claimed and/or disclosed inventive concepts include a method of fluid conditioning, including the steps of establishing a flow of a first fluid mixture containing at least one polar substance through a magnetically conductive conduit having magnetic energy directed along the longitudinal axis of the magnetically energized conduit and extending through at least a portion of the first fluid mixture thereby altering a dispersive surface tension and a polar surface tension of a conditioned fluid medium; and dispersing an amount of at least one dissimilar material into the conditioned fluid medium to form a continuous mixture. At least one chemical compound may also be dispersed in the first fluid mixture. At least one chemical compound may also be dispersed in the conditioned fluid medium.

At least one dissimilar material comprising a chemical compound may be selected from a group consisting of, but not limited to, algaecides, biocides, scale retardants, coagulants and flocculants, pesticides, fertilizers, surfactants, ambient air, oxygen, hydrogen, ozone and hydrogen peroxide. For example, reducing the surface tension of water allows lower amounts of algaecides, biocides and scale retardants to be used in thermal exchange systems to control bacteria and reduce the formation of mineral scale and other deposits. Coagulants and flocculants more readily disperse and are evenly distributed within a conditioned fluid medium, improving the clarification of raw water. Reduced surface tension of irrigation water allows pesticides, fertilizers, and surfactants added to water to be more efficiently broadcast to crops. Reducing the surface tension improves the mechanical blending of oxygen, hydrogen, ozone and hydrogen peroxide in water so that they are more readily dispersed and evenly distributed within a conditioned water medium. For example, improved dispersion and even distribution of oxygen injected into aqueous-based fluid mixtures results in smaller oxygen bubbles saturating water-based streams flowing into aeration basins, aerobic digesters, industrial processes and/or chemical reactions and provides greater concentrations of oxygen to be dispersed throughout the water column for improved fluid processing.

As disclosed herein, magnetic conditioning of a fluid mixture containing at least one polar substance was determined to alter a dispersive surface tension and a polar surface tension of a conditioned fluid medium and improve the mechanical blending of two or more distinct phases into a homogenous mixture. The dissolution behavior of high protein milk powder (MPC80) in water was studied.

For this purpose, ten percent milk protein solutions were prepared using untreated tap water (control), tap water directed to make approximately 5 passes through magnetic energy inducing a positive polarity, tap water directed to make approximately 5 passes through magnetic energy inducing a negative polarity. Ten grams of MPC80 powder were mixed with 90 g of untreated tap water, ten grams of MPC80 powder were mixed with 90 g of water directed to make multiple passes through magnetic energy inducing a positive polarity, and ten grams of MPC80 powder were mixed with 90 g of water directed to make multiple passes through magnetic energy inducing a negative polarity. The dissolution behavior of each milk protein solution was observed using an ultrasound spectrometer.

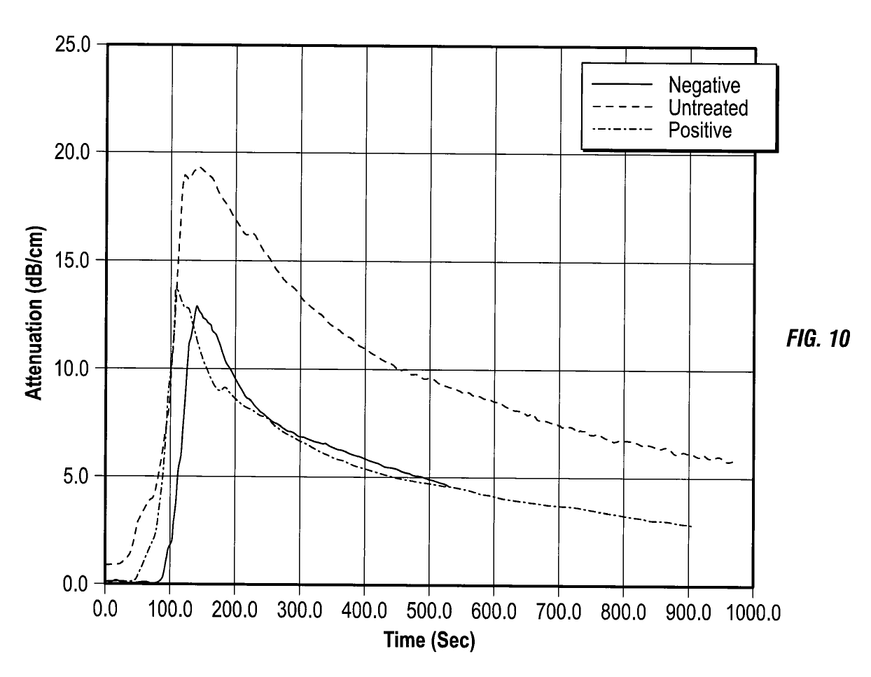

FIG. 10 is a graph showing the changes in the ultrasound attenuation over time during the dissolution of the MPC80 in each sample. As shown in FIG. 10, the attenuation began to increase in all the samples when the powder was added to the water. However, the samples generated with the magnetically conditioned water each displayed a significantly lower initial attenuation than with the sample generated with untreated tap water.

Lower initial attenuation indicates the MPC80 was more readily dispersed and evenly distributed within each conditioned fluid medium solution. In other words, the MPC80 was less likely to form large aggregates in the water and the powder was mixing more efficiently due to improved wetting of the particles by a conditioned fluid medium.

Altering a dispersive surface tension and a polar surface tension of a fluid improves the mechanical blending of two or more distinct phases into homogenous mixtures that will not readily separate into distinct phases over time. A fundamental understanding of the properties of drilling fluids (i.e., “mud”, “drilling mud”, or “drilling fluid”) is essential for safe and efficient oil and gas exploration and production activities.

Mud density is used to provide hydrostatic pressure to control a well during drilling operations and is normally reported in pounds per gallon. The viscosity of a drilling fluid is defined as its internal resistance of fluid flow. Yield point (YP) of a drilling fluid is the resistance to initial flow, or the stress required to initiate fluid movement. Yield point is used to evaluate the ability of mud to lift cuttings. A higher yield point implies that a drilling fluid has the ability to carry cuttings better than a fluid of similar density but lower yield point.

Plastic viscosity (PV) of a drilling fluid is the slope of the shear stress-shear rate plot above the yield point of the fluid. A low plastic viscosity indicates mud may be utilized for rapid drilling due to its low viscosity as it exits a bit. A high plastic viscosity is created as excess colloidal solids are entrained in a viscous base fluid.

Utilizing the previously disclosed method of generating untreated and magnetically conditioned fluid samples, wherein a closed loop system having a five gallon collection vessel, a 12 VDC diaphragm pump energized with a variable power supply, a flow meter and an embodiment of the presently claimed and/or disclosed magnetically conductive conduit connected with ½″ plastic tubing (that would not affect physical properties of a fluid sample) was utilized to generate untreated and magnetically conditioned fluid samples; as disclosed herein, magnetic conditioning of a fluid mixture containing at least one polar substance was determined to alter a dispersive surface tension and a polar surface tension of a conditioned fluid medium and affect the viscosity of the conditioned fluid medium.

Three gallons of a water-based drilling fluid (also known as “drilling mud” or “mud”) containing bentonite, salts, polymers, scale inhibitors, and other additives were decanted into the collection vessel. The pump was energized and power supply adjusted to circulate the drilling fluid through the system at a rate of 2.0 gpm. After circulating the drilling fluid for 5 minutes to achieve a steady-state flow, a first sample of untreated drilling fluid was collected and the plastic viscosity and yield point of the untreated drilling fluid were measured by utilizing a viscometer rotating at 300 rpm and 600 rpm to determine the viscosity of the fluid. Untreated drilling fluid had a plastic viscosity of 27 and a yield point of 24 dynes/cm².

A coiled electrical conductor encircling the magnetically conductive conduit was then energized with 12 VDC and approximately 5 amps of electrical energy. A second sample of drilling fluid, directed to make only one pass through an area of magnetic conditioning having a first polarity concentrated along a path extending through the electrical conductor encircling the outer surface of the magnetically energized conduit generating approximately 1000 gauss (unit of magnetic field measurement) of magnetic energy, as well as approximately 150 gauss of magnetic energy concentrated at each end of the magnetically energized conduit, was collected to determine the viscosity of the fluid. Utilizing the same viscometer rotating at 300 rpm and 600 rpm, no significant change in the viscosity of the fluid was measured after only one pass through the magnetically energized conduit.

However, after circulating the drilling fluid through the magnetically energized conduit so that it made approximately 5 passes through magnetic energy inducing the first polarity, the viscosity of the drilling fluid was reduced as indicated by a drop in the plastic viscosity from 27 cP to 24 cP and a drop in the yield point from 24 dynes/cm² to 18 dynes/cm². After circulating the drilling fluid through the magnetically energized conduit for approximately 10 additional passes through the first polarity, the viscosity of the drilling fluid was further reduced as indicated by a drop in the plastic viscosity from 24 cP to 20 cP and the yield point increased from 18 dynes/cm² to 21 dynes/cm² for a net drop in yield point of 12.5%.

The magnetically conditioned drilling fluid having the reduced plastic viscosity and yield point as a result of making 15 passes through the magnetically energized conduit was then circulated through the closed loop system so that the drilling fluid made approximately 17 passes through the magnetically energized conduit inducing magnetic energy having a second polarity, the plastic viscosity of the drilling fluid increased from 20 cP to 22 cP and its yield point increased from 20 dynes/cm² to 24 dynes/cm². These results are shown in Table VI.

TABLE VI
Water-based Drilling Fluid Viscosity
Untreated and Magnetic Conditioning (Flowing through Magnet)

| Untreated | | | | |
|---|---|---|---|---|
| Drilling | Conditioning | | Conditioning | |
| Fluid | w/ 1st Polarity | % Change | w/ 2nd Polarity | % Change |
| PV/ | PV/ | From | PV/ | From |
| YP | YP | Untreated | YP | 1st Polarity |
| 27 cP/ | 20 cP/ | −25.9%/ | 22 cP/ | +10.0%/ |
| 24 dyn/cm2 | 21 dyn/cm2 | −12.5% | 24 dyn/cm2 | +14.3% |

The presently claimed and/or disclosed inventive concepts also include a method of altering the physical properties of a fluid mixture containing at least one polar substance at ambient temperature, including the step of passing the fluid mixture through a magnetically conductive conduit having magnetic energy directed along the longitudinal axis of the magnetically energized conduit and extending through at least a portion of the fluid mixture thereby altering a dispersive surface tension and a polar surface tension of a conditioned fluid medium. Inducing a first magnetic polarity reduces the viscosity of the conditioned fluid medium and inducing a second magnetic polarity increases the viscosity of the conditioned fluid medium, for example.

Utilizing the previously disclosed method of generating untreated and magnetically conditioned fluid samples, wherein a high throughput peristaltic pump (to prevent direct contact with the fluid samples) was used to propel the fluid samples through tubing (being made of a material that, in and of itself, would not affect any physical properties of a fluid mixture sample) sleeved by a non-energized magnetically conductive conduit and a magnetically energized conduit at a flow rate of 1150 ml/min; as disclosed herein, magnetic conditioning of a fluid mixture containing at least one polar substance was determined to alter a dispersive surface tension and a polar surface tension of distilled water.

A first sample of untreated distilled water was collected in a certified clean container after being directed to make only one pass through the length of non-energized magnetically conductive conduit. The sample flowed uncollected for approximately 30 to 45 seconds to allow for the dismissal of any bubbles so that the untreated distilled water sample was collected during steady-state flow.

A second sample of the distilled water was collected in a certified clean container after energizing a coiled electrical conductor encircling the conduit with 12 VDC and approximately 5 amps of electrical energy and directing the distilled water to make only one pass through a magnetically energized conduit having an area of magnetic conditioning concentrated along a path extending through at least one turn of the electrical conductor encircling the outer surface of the magnetically conductive conduit generating approximately 850 gauss (unit of magnetic field measurement) of magnetic energy, as well as approximately 150 gauss of magnetic energy concentrated at each end of the magnetically conductive conduit. The magnetically conditioned distilled water sample was similarly allowed to flow uncollected for approximately 30 to 45 seconds to allow for the dismissal of any bubbles so that the water sample was collected during steady-state flow. The overall surface tensions of both untreated and magnetically conditioned distilled water samples were measured by the Wilhelmy plate method. Both samples were also tested for contact angle against a standard PTFE surface in order to determine the fraction of the overall surface tension of each sample making up their non-polar surface tensions.

Results are shown in Table VII.

TABLE VII
Component Surface Tension Information After Magnetic Conditioning
Distilled Water - (Flowing through Magnet)

| | Overall | Dispersive | Polar | |
|---|---|---|---|---|
| Time After | Surface | Surface | Surface | Surface |
| Conditioning | Tension | Tension | Tension | Polarity |
| (hours) | (mN/m) | (mN/m) | (mN/m) | (%) |
| 0 | 72.72 | 24.89 | 47.83 | 65.8 |
| 1 | 72.73 | 25.03 | 47.70 | 65.6 |
| 8 | 72.75 | 26.01 | 46.74 | 64.2 |
| 24 | 72.74 | 26.42 | 46.32 | 63.7 |
| 36 | 72.73 | 26.56 | 46.17 | 63.5 |
| 48 | 72.74 | 26.57 | 46.17 | 63.5 |

Untreated distilled water had an overall surface tension of 72.74 mN/M while magnetically conditioned distilled water had an overall surface tension of 72.72 mN/M, a value within a measurable margin of error indicating there was no change in the surface tension of the magnetically conditioned distilled water. However, untreated distilled water had a dispersive surface tension of 26.57 mN/M, a polar surface tension of 46.17 mN/M and a surface polarity of 63.5% while magnetically conditioned distilled water had a dispersive surface tension of 24.89 mN/M, a polar surface tension of 47.83 mN/M and a surface polarity of 65.8%, indicating significant changes in a dispersive surface tension and a polar surface tension of magnetically conditioned distilled water. Changes in the dispersive surface tension, polar surface tension and surface polarity of the distilled water sample directed to make one pass through the magnetically conductive conduit were greatest immediately after magnetic conditioning, with each property of the magnetically conditioned water sample returning to its untreated dispersive surface tension, polar surface tension and surface polarity value in less than 48 hours.

The presently claimed and/or disclosed inventive concepts also include a method of altering the physical properties of distilled water at ambient temperature, including the step of passing a first volume of distilled water through a magnetically conductive conduit having magnetic energy directed along the longitudinal axis of the magnetically energized conduit and extending through at least a portion of the distilled water thereby providing a conditioned distilled water medium, wherein a dispersive surface tension of the conditioned distilled water medium is lower than a dispersive surface tension of the first volume of distilled water and a polar surface tension of the conditioned distilled water medium is higher than a polar surface tension the first volume of distilled water.

The presently claimed and/or disclosed inventive concepts also include an apparatus for altering a dispersive surface tension and a polar surface tension of a fluid containing at least one polar substance at ambient temperature, including a magnetically conductive conduit having magnetic energy directed along the longitudinal axis of a magnetically energized conduit and extending through at least a portion of the magnetically conductive conduit. The magnetically conductive conduit may have a fluid entry port at the proximal end of the magnetically conductive conduit, a fluid discharge port at the distal end of the magnetically conductive conduit and a fluid impervious boundary wall having an inner surface and an outer surface extending between the fluid entry port and the fluid discharge port, the inner surface of the boundary wall establishing a fluid flow path extending along the longitudinal axis of the conduit. The magnetically conductive conduit may further have at least one electrical conductor having a first conductor lead and a second conductor lead, the electrical conductor coiled with at least one turn to form at least one uninterrupted coil of electrical conductor, each coil forming at least one layer of coiled electrical conductor. The magnetically conductive conduit may further include at least one coiled electrical conductor encircling the magnetically conductive conduit within the coiled electrical conductor, wherein the at least one coiled electrical conductor sleeves at least a section of an outer surface of the boundary wall of the magnetically conductive conduit with at least one turn of the electrical conductor oriented substantially orthogonal to the fluid flow path extending through the conduit. The magnetically conductive conduit may further have at least one electrical power supply operably connected to at least one of the first and second conductor leads, wherein the at least one coiled electrical conductor is thereby energized to provide a magnetic field having lines of flux directed along a longitudinal axis of the magnetically energized conduit. In each embodiment of the presently claimed and/or disclosed inventive concepts for altering a dispersive surface tension and a polar surface tension of a fluid, it can be appreciated that magnetic energy may be concentrated in a plurality of distinct areas along the longitudinal axis of the magnetically energized conduit.

FIG. 6A is an embodiment of the presently claimed and/or disclosed inventive concepts for increasing the flow rate of a fluid mixture propelled through a conduit under pressure at ambient temperature. A fluid mixture containing at least one polar substance may be introduced to port 41 may be directed to pass through magnetically conductive conduit 42 having magnetic energy directed along the longitudinal axis of the magnetically energized conduit and extending through at least a portion of the fluid mixture, thereby altering a dispersive surface tension and a polar surface tension of a conditioned fluid medium discharged from port 44.

As disclosed herein, experimentation has shown magnetic conditioning as described in the presently claimed and/or disclosed inventive concepts alters at least one physical property of a fluid flowing under pressure. The presently claimed and/or disclosed inventive concepts also include a method of reducing a pressure to propel a fluid mixture containing at least one polar substance, including the steps of establishing a flow of a first fluid mixture containing at least one polar substance through a magnetically conductive conduit having magnetic energy directed along the longitudinal axis of the magnetically energized conduit and extending through at least a portion of the first fluid mixture thereby providing a conditioned fluid medium; and directing a volume of the conditioned fluid medium to flow through a constricted region, wherein the pressure required to propel a volume of the conditioned fluid medium through the constricted region is reduced as compared to the pressure required to propel a substantially identical volume of the first fluid mixture through the constricted region.

The presently claimed and/or disclosed inventive concepts also include a method of reducing a pressure to pass a fluid mixture containing at least one polar substance through a conduit at ambient temperature, including the steps of establishing a flow of a first fluid mixture containing at least one polar substance through a magnetically conductive conduit having magnetic energy directed along the longitudinal axis of the magnetically energized conduit and extending through at least a portion of the first fluid mixture thereby providing a conditioned fluid medium; and passing the conditioned fluid medium at a constant flow rate through a conduit downstream of the magnetically conductive conduit, wherein the pressure required to pass a volume of the conditioned fluid medium at a constant flow rate through the conduit at ambient temperature is reduced as compared to the pressure required to pass a substantially identical volume of the first fluid mixture at a substantially identical constant flow rate through the conduit at ambient temperature.

Utilizing the previously disclosed method of generating untreated and magnetically conditioned fluid samples, wherein a closed loop system having a five gallon collection vessel, a 12 VDC diaphragm pump energized with a variable power supply, a flow meter and an embodiment of the presently claimed and/or disclosed magnetically conductive conduit connected with new ½″ plastic tubing (that would not affect physical properties of a fluid sample) was utilized to generate untreated and magnetically conditioned fluid samples; as disclosed herein, magnetic conditioning of a fluid mixture containing at least one polar substance was determined to increase the flow rate of a fluid mixture propelled through a conduit under pressure at ambient temperature.

Four gallons of tap water were decanted into the collection vessel, the pump was energized and power supply adjusted to circulate the water through the system at a rate of 4.0 gpm. After circulating the water for 5 minutes to achieve a steady-state flow, a first sample of untreated tap water was collected in a collapsible plastic bladder. The water sample was then placed in a pneumatically driven flow evaluation system, wherein air pressure compressed the collapsible plastic bladder to propel the water sample through an adjustable solenoid valve and a 30″ length of 3/16″ stainless steel tubing before being decanted into a sample collection flask.

The solenoid valve, having a capacity to regulate fluid flow through an adjustable orifice at a predetermined pressure, was connected to an electric timer utilized to regulate the length of time the valve was open to allow for pneumatically driven fluid flow. Flow rates through the system were then determined by dividing the volume of water collected in the sample flask by the amount of time the solenoid valve was open to allow fluid to flow through the valve. The average flow rate of untreated water propelled at 20 psi through the system was determined to be 17.2 milliliters per second, or 0.0273 gpm and the average flow rate of untreated water propelled at 40 psi was determined to be 21.6 milliliters per second, or 0.0342 gpm.

A coiled electrical conductor encircling the magnetically conductive conduit was then energized with 12 VDC and approximately 5 amps of electrical energy. A second 4 gallon sample of tap water was circulated through the magnetically energized closed loop conditioning system at a rate of 4.0 gpm for approximately 10 minutes before a collecting a sample of conditioned tap water after it made approximately 10 passes through a magnetically energized conduit.

The magnetically conditioned water sample was then placed in the pneumatically driven flow evaluation system and samples were generated with water propelled through the solenoid valve at 20 psi and 40 psi. The average flow rate of magnetic conditioned water propelled at 20 psi through the flow evaluation system was determined to be 18.4 milliliters per second, or 0.0292 gpm; a 7.0% increase in flow rate as a result of magnetic conditioning and the average flow rate of magnetic conditioned water propelled at 40 psi through the flow evaluation system was determined to be 26.2 milliliters per second, or 0.0415 gpm, an increased flow rate of 21.3% as a result of magnetic conditioning. These results are shown in Table VIII.

TABLE VIII
Tap Water Propelled Through a Conduit at Pressure
Untreated and Magnetic Conditioning (Flowing through Magnet)

| | Magnetic | | | | |
|---|---|---|---|---|---|
| Untreated | Condition- | | Untreated | Magnetic | |
| Tap Water | ing | % Change | Tap Water | Conditioning | % Change |
| 20 psi | 20 psi | @ 20 psi | 40 psi | 40 psi | @ 40 psi |
| .0273 gpm | .0292 gpm | 7.0% | .0342 gpm | .0415 gpm | 21.3% |

The presently claimed and/or disclosed inventive concepts also include a method of increasing the flow rate of a fluid mixture propelled through a conduit under pressure at ambient temperature, including the steps of establishing a flow of a first fluid mixture containing at least one polar substance through a magnetically conductive conduit having magnetic energy directed along the longitudinal axis of the magnetically energized conduit and extending through at least a portion of the first fluid mixture thereby providing a conditioned fluid medium; and propelling the conditioned fluid medium under pressure through a conduit downstream of the magnetically conductive conduit, wherein the flow rate of a volume of the conditioned fluid medium propelled at a constant pressure through the conduit at ambient temperature is increased as compared to the flow rate of a substantially identical volume of the first fluid mixture propelled at a substantially identical constant pressure through the conduit at ambient temperature.

The presently claimed and/or disclosed inventive concepts also include a method of increasing the flow rate of a fluid mixture containing at least one polar substance, including the steps of establishing a flow of a first fluid mixture containing at least one polar substance through a magnetically conductive conduit having magnetic energy directed along the longitudinal axis of the magnetically energized conduit and extending through at least a portion of the first fluid mixture thereby providing a conditioned fluid medium; and directing a volume of the conditioned fluid medium to flow through a constricted region, wherein the flow rate of a volume of the conditioned fluid medium propelled through the constricted region is increased as compared to the flow rate of a substantially identical volume of the first fluid mixture propelled through the constricted region.

The presently claimed and/or disclosed inventive concepts further include an apparatus for altering at least one physical property of a fluid containing at least one polar substance flowing under pressure at ambient temperature, including a magnetically conductive conduit having magnetic energy directed along the longitudinal axis of a magnetically energized conduit and extending through at least a portion of the magnetically conductive conduit. The magnetically conductive conduit may have a fluid entry port at the proximal end of the magnetically conductive conduit, a fluid discharge port at the distal end of the magnetically conductive conduit and a fluid impervious boundary wall having an inner surface and an outer surface extending between the fluid entry port and the fluid discharge port, the inner surface of the boundary wall establishing a fluid flow path extending along the longitudinal axis of the conduit. The magnetically conductive conduit may further have at least one electrical conductor having a first conductor lead and a second conductor lead, the electrical conductor coiled with at least one turn to form at least one uninterrupted coil of electrical conductor, each coil forming at least one layer of coiled electrical conductor. The magnetically conductive conduit may further include at least one coiled electrical conductor encircling the magnetically conductive conduit within the coiled electrical conductor, wherein the at least one coiled electrical conductor sleeves at least a section of an outer surface of the boundary wall of the magnetically conductive conduit with at least one turn of the electrical conductor oriented substantially orthogonal to the fluid flow path extending through the conduit. The magnetically conductive conduit may further have at least one electrical power supply operably connected to at least one of the first and second conductor leads, wherein the at least one coiled electrical conductor is thereby energized to provide a magnetic field having lines of flux directed along a longitudinal axis of the magnetically energized conduit.

In each embodiment of the presently claimed and/or disclosed inventive concepts for altering at least one physical property of a fluid containing at least one polar substance flowing under pressure at ambient temperature, it can be appreciated that magnetic energy may be concentrated in a plurality of distinct areas along the longitudinal axis of the magnetically energized conduit.

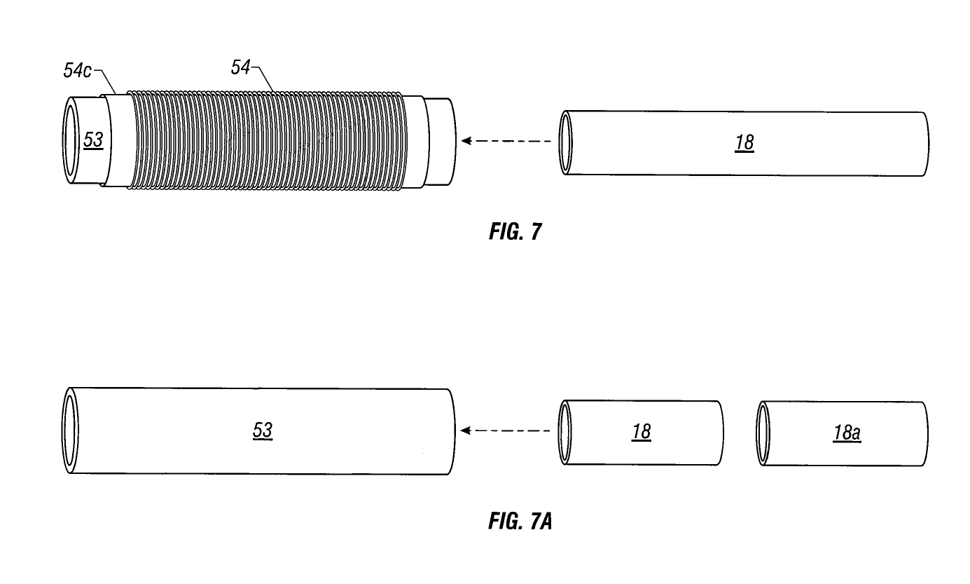

Increasing the density and thickness of the fluid impervious boundary wall of the magnetically conductive conduit typically results in greater concentrations of magnetic energy within each section of magnetically conductive conduit and non-magnetically conductive regions established between magnetically conductive conduits. Embodiment of the magnetically conductive conduit wherein at least one length of magnetically conductive material sleeves at least one additional length of magnetically conductive material may be utilized to increase the density and thickness of the fluid impervious boundary wall of the magnetically conductive conduit. FIG. 7 schematically depicts an alternate embodiment of the magnetically conductive conduit having more than one length of magnetically conductive material forming the magnetically conductive conduit with an exploded view of first length of magnetically conductive conduit segment 53 adapted to sleeve second length of magnetically conductive conduit segment 18, whereby at least a section of the inner surface of the boundary wall of magnetically conductive conduit segment 53 may be coaxially disposed in substantially concentric surrounding relation to at least a section of the outer surface of the boundary wall of magnetically conductive conduit segment 18. The inner surface of the boundary wall of conduit segment 18 establishes a fluid flow path extending along the longitudinal axis of the magnetically conductive conduit. Coiled electrical conductor 54 is shown encircling coil core 54c.

Coil core 54c is shown sleeving a section of conduit segment 53 so that at least one turn of the coiled electrical conductor encircles at least a section of the outer surface of magnetically conductive conduit segment 53. As magnetically conductive conduit segment 53 sleeves magnetically conductive conduit segment 18, at least one turn of the coiled electrical conductor may encircle at least a section of each length of magnetically conductive material with at least one turn of the electrical conductor oriented substantially orthogonal to the fluid flow path extending through the magnetically conductive conduit.

FIG. 7A schematically depicts an alternate embodiment of the magnetically conductive conduit having more than one length of magnetically conductive material forming the magnetically conductive conduit with an exploded view of magnetically conductive conduit segment 53 adapted to sleeve the non-contiguous array of magnetically conductive conduit segment 18 and magnetically conductive conduit segment 18a, whereby at least a section of the inner surface of the boundary wall of magnetically conductive conduit segment 53 may be coaxially disposed in substantially concentric surrounding relation to at least a section of the outer surface of the boundary wall of magnetically conductive conduit segment 18, a non-magnetically conductive region between the distal end of magnetically conductive conduit segment 18 and the proximal end of magnetically conductive conduit segment 18a, and at least a section of the outer surface of the boundary wall of magnetically conductive conduit segment 18a.

A spacer made of a non-magnetically conductive material may be utilized to maintain the non-magnetically conductive region between the distal end of magnetically conductive conduit segment 18 and the proximal end of magnetically conductive conduit segment 18a. The inner surfaces of the boundary walls of magnetically conductive conduit segment 18 and magnetically conductive conduit segment 18a establish a flow path extending along the longitudinal axis of the magnetically conductive conduit. As magnetically conductive conduit segment 53 sleeves the non-contiguous array of magnetically conductive conduit segment 18 and magnetically conductive conduit segment 18a, at least one turn of at least one coiled electrical conductor encircling at least a section of the outer surface of magnetically conductive conduit segment 53 may encircle at least a section of each length of magnetically conductive material with at least one turn of the electrical conductor oriented substantially orthogonal to the fluid flow path extending through the magnetically conductive conduit.

FIG. 7B schematically depicts an alternate embodiment of the magnetically conductive conduit having more than one length of magnetically conductive material forming the magnetically conductive conduit with an exploded view of magnetically conductive conduit segment 53 adapted to sleeve a serial coupling of magnetically conductive conduit segment 18, non-magnetically conductive conduit segment 18b and magnetically conductive conduit segment 18a. The inner surfaces of the boundary walls of magnetically conductive conduit segment 18, non-magnetically conductive conduit segment 18b and magnetically conductive conduit segment 18a establish a fluid flow path extending along the longitudinal axis of the magnetically conductive conduit. As magnetically conductive conduit segment 53 sleeves the serial coupling of magnetically conductive conduit segment 18, non-magnetically conductive conduit segment 18b and magnetically conductive conduit segment 18a, at least one turn of at least one coiled electrical conductor encircling at least a section of the outer surface of magnetically conductive conduit segment 53 may encircle at least a section of each length of magnetically conductive material with at least one turn of the electrical conductor oriented substantially orthogonal to the fluid flow path extending through the magnetically conductive conduit. In an alternate embodiment of the magnetically conductive conduit having more than one length of magnetically conductive material forming the magnetically conductive conduit, a first segment of magnetically conductive material may be adapted to sleeve at least a section of the outer surface of magnetically conductive conduit segment 18 and a second segment of magnetically conductive material may be adapted to sleeve at least a section of the outer surface of magnetically conductive conduit segment 18a.

FIG. 7C schematically depicts an alternate embodiment of the magnetically conductive conduit having more than one length of magnetically conductive material forming the magnetically conductive conduit with an exploded view of first serial coupling of magnetically conductive conduit segment 53, non-magnetically conductive conduit segment 53a and magnetically conductive conduit segment 53b adapted to sleeve second serial coupling of magnetically conductive conduit segment 18, non-magnetically conductive conduit segment 18b and magnetically conductive conduit segment 18a. The inner surfaces of the boundary walls of magnetically conductive conduit segment 18, non-magnetically conductive conduit segment 18b and magnetically conductive conduit segment 18a establish a fluid flow path extending along the longitudinal axis of the magnetically conductive conduit. As magnetically conductive conduit segment 53, non-magnetically conductive conduit segment 53a and magnetically conductive conduit segment 53b sleeve magnetically conductive conduit segment 18, non-magnetically conductive conduit segment 18b and magnetically conductive conduit segment 18a, at least one turn of at least one coiled electrical conductor encircling at least a section of the outer surface of magnetically conductive conduit segment 53 and at least a section of the outer surface of magnetically conductive conduit segment 53b may encircle at least a section of each length of magnetically conductive material with at least one turn of the electrical conductor oriented substantially orthogonal to the fluid flow path extending through the magnetically conductive conduit.

In large diameter conduits, a nucleus made of a magnetically conductive material and having an outer surface may be deployed within the aperture of a magnetically conductive conduit to promote an increased concentration of magnetic energy within the cross section of a fluid flow path extending through the conduit. Deploying a magnetically conductive nucleus within a non-magnetically conductive region between segments of magnetically energized conduit forming the magnetically conductive conduit provides an increased concentration of magnetic energy within the fluid flow path as the magnetically conductive nucleus is concentrically attracted by the magnetically energized conduit segments.

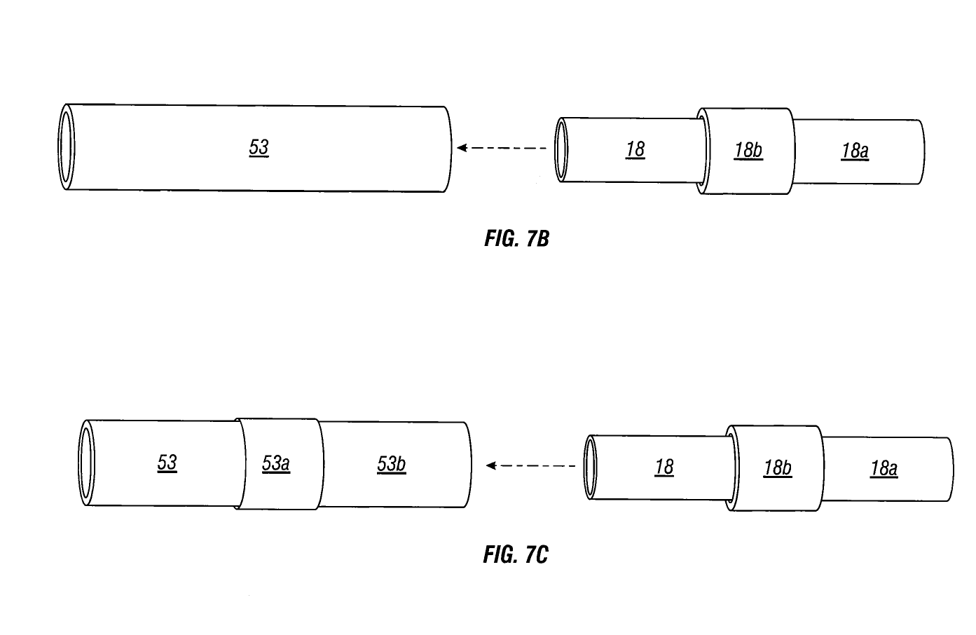

FIG. 8 schematically depicts an alternate embodiment of the magnetically conductive conduit having more than one length of magnetically conductive material forming the magnetically conductive conduit with serial coupling of magnetically conductive conduit segment 18, non-magnetically conductive conduit segment 18b and magnetically conductive conduit segment 18a establishing a fluid flow path extending along the longitudinal axis of the magnetically conductive conduit. Magnetically conductive nucleus 39 is made of a magnetically conductive material and has an outer surface. The nucleus may be deployed within non-magnetically conductive conduit segment 18b by utilizing a non-magnetically conductive material to make at least one mechanical connection extending between the inner surface of the boundary wall of conduit segment 18b and the outer surface of magnetically conductive nucleus 39. The inner surface of the boundary walls of magnetically conductive conduit segment 18 and magnetically conductive conduit segment 18a are shown in coaxial alignment to the outer surface of magnetically conductive nucleus 39. At least one coiled electrical conductor may encircle at least a section of each length of magnetically conductive conduit with at least one turn of the electrical conductor oriented substantially orthogonal to the fluid flow path extending through the magnetically conductive conduit. Fluid flowing through a serial coupling of magnetically conductive conduit segment 18, non-magnetically conductive conduit segment 18b and magnetically conductive conduit segment 18a may be exposed to high concentrations of magnetic energy as it flows between the inner surface of the boundary wall of conduit segment 18b and the outer surface of magnetically conductive nucleus 39.

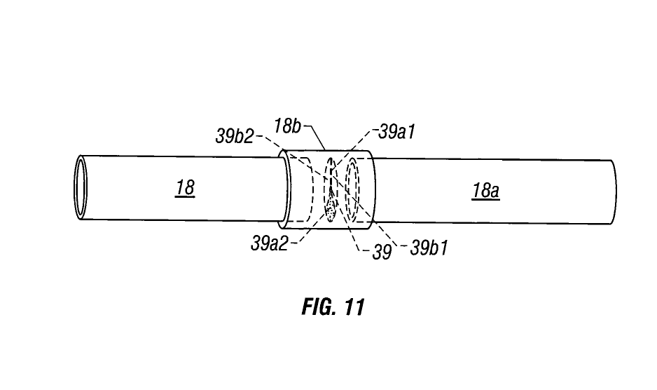

FIG. 11 schematically depicts an alternate embodiment of the magnetically conductive conduit having more than one length of magnetically conductive material forming the magnetically conductive conduit with serial coupling of magnetically conductive conduit segment 18, non-magnetically conductive conduit segment 18b and magnetically conductive conduit segment 18a establishing a fluid flow path extending along the longitudinal axis of the magnetically conductive conduit. Magnetically conductive nucleus 39 is made of a magnetically conductive material and has an outer surface. The magnetically conductive nucleus 39 may be deployed within non-magnetically conductive conduit segment 18b by utilizing one or more pieces of non-magnetically conductive material 39a to make at least one mechanical connection extending between the inner surface of the boundary wall of conduit segment 18b and the outer surface of magnetically conductive nucleus 39. As shown in FIG. 11, the non-magnetically conductive material 39a making a mechanical connection between the inner surface of the boundary wall of conduit segment 18b and the outer surface of magnetically conductive nucleus 39 may have two components 39a1 and 39a2 which define two openings 39b1 and 39b2 to permit passage of fluid past the magnetically conductive nucleus 39 to form a static mixing device within the fluid flow path extending through the conduit segment 18b. As shown in FIG. 11, the non-magnetically conductive material 39a2 may form a restriction within the conduit segment 18b by encompassing from about 30 degrees to about 180 degrees of cross-sectional area of the conduit segment 18b. The size of the openings 39b1 and 39b2 can collectively vary from about 330 degrees to about 180 degrees of the cross-sectional area of the conduit segment 18b. For example, the openings 39b1 and 39b2 depicted in FIG. 11 collectively encompass approximately 240 degrees of the cross-sectional area of the conduit segment 18b. The inner surface of the boundary walls of the magnetically conductive conduit segment 18 and magnetically conductive conduit segment 18a are shown in coaxial alignment to the outer surface of magnetically conductive nucleus 39. In some embodiments, the magnetically conductive nucleus 39 is formed of a permanent magnet.

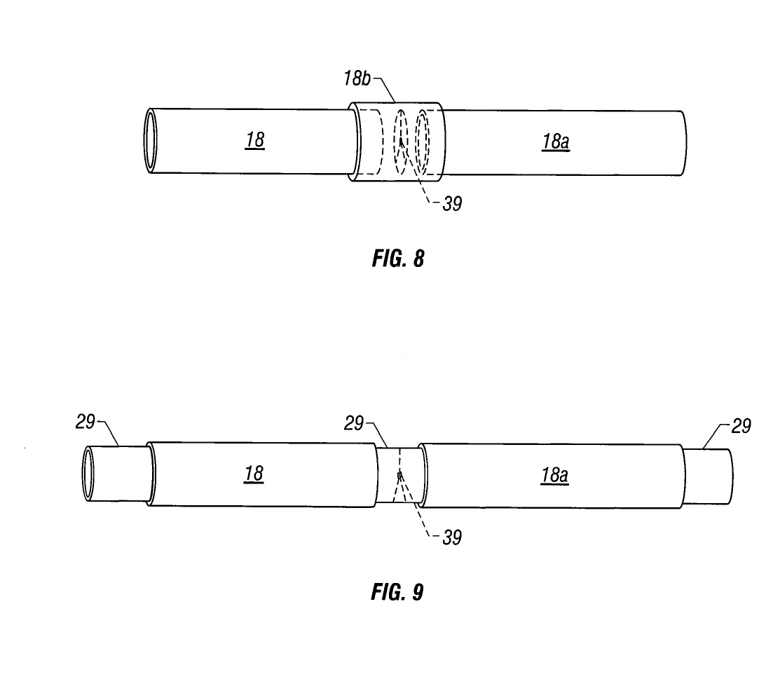

FIG. 9 schematically depicts an alternate embodiment of the magnetically conductive conduit having more than one length of magnetically conductive material forming the magnetically conductive conduit with a non-contiguous array of first length of magnetically conductive conduit segment 18 and second length of magnetically conductive conduit segment 18a forming the magnetically conductive conduit. A spacer made of a non-magnetically conductive material may be utilized to maintain the non-magnetically conductive region between the distal end of conduit segment 18 and the proximal end of conduit segment 18a. The inner surface of the boundary wall of magnetically conductive conduit segment 18 and the inner surface of the boundary wall of magnetically conductive conduit segment 18a define a flow path extending along the longitudinal axis of the magnetically conductive conduit. Fluid flow conduit 29, made with a length of non-magnetically conductive material defining a fluid impervious boundary wall with an inner surface and an outer surface and having a fluid entry port at one end of the conduit and a fluid discharge port at the other end of the conduit, is shown extending through magnetically conductive conduit segment 18 and magnetically conductive conduit segment 18a to establish a fluid flow path through the magnetically conductive conduit. Magnetically conductive nucleus 39 is made of a magnetically conductive material and has an outer surface and is shown deployed within the aperture of non-magnetically conductive fluid flow conduit 29. The inner surface of the boundary walls of magnetically conductive conduit segment 18 and magnetically conductive conduit segment 18a are shown in coaxial alignment to the outer surface of magnetically conductive nucleus. The nucleus may be deployed within non-magnetically conductive fluid flow conduit 29 by utilizing a non-magnetically conductive material to make at least one mechanical connection extending between the inner surface of the boundary wall of non-magnetically conductive fluid flow conduit 29 and the outer surface of magnetically conductive nucleus 39. At least one coiled electrical conductor may encircle at least a section of each length of magnetically conductive conduit with at least one turn of the electrical conductor oriented substantially orthogonal to the fluid flow path extending through the magnetically conductive conduit. Fluid flowing along a path extending through non-magnetically conductive conduit 29 sleeved by magnetically energized conduit segment 18 and magnetically energized conduit segment 18a may be exposed to high concentrations of magnetic energy as it flows between the inner surface of the boundary wall of fluid flow conduit 29 and the outer surface of magnetically conductive nucleus 39.

The electrical conductor may have at least one strand of electrical conducting material, such as a length of wire, or have at least one sheet of an electrical conducting foil material. A single length of electrical conducting material may be coiled to form a single layer of coiled electrical conductor, or form a first layer and second layer of coiled electrical conductor. A first length of electrical conducting material may be coiled to form a first layer of coiled electrical conductor and a second length of electrical conducting material may be coiled to form a second layer of coiled electrical conductor. A side-by-side array of a first length of electrical conducting material and a second length of electrical conducting material may be coiled in a substantially parallel orientation to form at least one layer of coiled electrical conductor.

First and second layers of coiled electrical conductor may be coaxially disposed and have a plurality of spacers deployed between the layers to establish radial spacing there between. The spacers may be arranged substantially parallel to the longitudinal axis of the magnetically conductive conduit and equidistant to an adjacent spacer to form a pattern of open-air cooling ducts extending substantially parallel to the longitudinal axis of the magnetically conductive conduit, said cooling ducts having a capacity to dissipate heat from between coil layers.

A non-contiguous array of a first coil of electrical conducting material and a second coil of electrical conducting material may encircle the magnetically conductive conduit, or a non-contiguous array of a first coil of electrical conducting material encircling a coil core and a second coil of electrical conducting material encircling a coil core may sleeve the magnetically conductive conduit. A space between a non-contiguous array of first coil of electrical conducting material and a second coil of electrical conducting material may establish a cooling duct extending substantially orthogonal to the longitudinal axis of the magnetically conductive conduit, with the cooling duct having a capacity to dissipate heat from between the first coil of electrical conducting material and a second coil of electrical conducting material.

A first non-magnetically conductive fluid flow conduit and a second non-magnetically conductive fluid flow conduit may be sleeved within the boundary wall of a magnetically energized conduit. A first fluid may be directed to pass through the first non-magnetically conductive fluid flow conduit and a second fluid may be directed to pass through the second non-magnetically conductive fluid flow conduit and exposed to at least one area of concentrated magnetic energy.

The at least one electrical power supply may energize the coiled electrical conductor with a constant output of electrical energy having a direct current component, an output of electrical energy having an alternating current component, a pulsed output of electrical energy having a direct current component, and/or a pulsed output of electrical energy having an alternating current component.

The at least one electrical power supply may establish an output of electrical energy having an alternating current component to energize at least one coiled electrical conductor through a switching sequence including initially energizing said at least one coiled electrical conductor during a first time interval with electrical energy flowing between the first conductor lead to the second conductor lead in a first direction, switching the direction of the flow of electrical energy and energizing said at least one coiled electrical conductor during a second time interval with electrical energy flowing between the first conductor lead to the second conductor lead in a second direction and causing the switching sequence to repeat at a repetition rate.

The at least one electrical power supply may establish a pulsed output of electrical energy having a direct current component through a switching sequence including initially switching an output of electrical energy to an “on” state during a first time interval to energize at least one coiled electrical conductor with electrical energy flowing from the first conductor lead to the second conductor lead, switching said first output of electrical energy to an “off” state to interrupt the energizing of said at least one coiled electrical conductor, switching an output of electrical energy to the “on” state during a second time interval to energize said at least one coiled electrical conductor with electrical energy flowing from the first conductor lead to the second conductor lead, switching said second output of electrical energy to the “off” state to interrupt the energizing of said at least one coiled electrical conductor and causing the switching sequence to repeat at a repetition rate. The first and second time intervals and the repetition rate may be substantially constant or one or more of the first and second time intervals and the repetition rate may be variable.

The at least one electrical power supply may establish a pulsed output of electrical energy having an alternating current component through a switching sequence including initially switching an output of electrical energy to an “on” state during a first time interval to energize at least one coiled electrical conductor with electrical energy flowing between the first conductor lead to the second conductor lead in a first direction, switching said first output of electrical energy to an “off” state to interrupt the energizing of said at least one coiled electrical conductor, reversing the direction of the flow of electrical energy, switching an output of electrical energy to the “on” state during a second time interval to energize said at least one coiled electrical conductor with electrical energy flowing between the first conductor lead to the second conductor lead in a second direction, switching said second output of electrical energy to the “off” state to interrupt the energizing of said at least one coiled electrical conductor and causing the switching sequence to repeat at a repetition rate. The first and second time intervals and the repetition rate may be substantially constant or one or more of the first and second time intervals and the repetition rate may be variable.

One or more of the voltage and current of the output of electrical energy may be substantially constant or one or more of the voltage and current of the output of electrical energy may be variable. One or more of the time intervals, repetition rate, or direction of a pulsed output of electrical energy may be established according to one or more of the material making up the coiled electrical conductor, resistance or impedance of the coiled electrical conductor and/or the configuration of the at least one coiled electrical conductor. The at least one power supply may provide a plurality of programmable outputs of electrical energy, each output of electrical energy establishing a distinct output of electrical energy wherein a first output of electrical energy energizes a first coiled electrical conductor and a second output of electrical energy energizes a second coiled electrical conductor. A first supply of electrical power and a second supply of electrical power may be connected in series or parallel to energize at least one coiled electrical conductor.

A first flow of electrical energy having a first set of electrical characteristics may be utilized to provide conditioning for a first fluid mixture, and a second flow of electrical energy having a second set of electrical characteristics may be used to provide conditioning for a second fluid mixture. One or more of the time intervals, repetition rate, voltage, current, or direction of a pulsed output of electrical energy may be programmable to provide effective fluid conditioning as the characteristics and substances comprising a fluid mixture change. The size, shape and dimensions of the electrical conducting material, the length to diameter ratio of the at least one coiled electrical conductor encircling the magnetically conductive conduit and/or the number of layers of coiled electrical conductor forming a coil may be adapted for specific applications.

Other variables may include the size, shape and material comprising the conduit and coupling segments; and the size, shape and composition of materials comprising an enclosure to protect at least the coiled electrical conductor. At least one magnetically conductive material or at least one non-magnetically conductive material may be utilized to maintain the spacing between a non-contiguous array of coils. At least one non-magnetically conductive material may be utilized to maintain the spacing between the outer layer of a coiled electrical conducting material and the inner surface of a protective coil enclosure.

Energizing the coiled electrical conductor with at least one pulsed output of electrical energy provides a variety of fluid conditioning benefits. In a first example, switching the output of electrical energy to an “off” state to interrupt the energizing of the at least one coiled electrical conductor may allow magnetically conductive debris that may adhere to the inner surface of the boundary wall of a magnetically energized conduit to be dislodged and removed by a flow of fluid passing through the non-energized magnetically conductive conduit.

In a second example, energizing the at least one coiled electrical conductor with pulsed outputs of electrical energy having rapid repetition rates may generate alternating positive and negative pressure waves in some fluids that tend to tear a fluid apart and create vacuum cavities that form micron-size bubbles. Such bubbles may continue to grow under the influence of the alternating positive and negative pressure waves until they reach a resonant size where they then collapse, or implode, under a force known as cavitation. Imploding bubbles form jets of plasma having extremely high temperatures that travel at high rates of speed for relatively short distances. Energy released from a single cavitation bubble is extremely small, but the cavitation of millions of bubbles every second has a cumulative effect throughout a fluid as the pressure, temperature and velocity of the jets of plasma destroy many contaminants in the fluid. In certain applications, diffused ambient air or other forms of small bubbles may be introduced immediately upstream of a magnetically energized conduit to assist in initiating the cavitation process. Electrolysis of water and other aqueous-based fluid mixtures may be utilized to generate small bubbles upstream of a magnetically conductive conduit energized with pulsed outputs of electrical energy.

As disclosed herein, the presently claimed and/or disclosed inventive concepts include a method of separating at least one biological contaminant from a fluid mixture containing at least one polar substance, having the step of establishing a flow of a first fluid mixture containing at least one polar substance and at least one biological contaminant through a magnetically conductive conduit having magnetic energy directed along the longitudinal axis of the magnetically energized conduit and extending through at least a portion of the first fluid mixture thereby providing a conditioned fluid medium; wherein the flow of at least a portion of the conditioned fluid medium through distinct areas of concentrated fluid conditioning energy destroys the membrane of at least one biological contaminant.

A variety of processes and methods have been devised in an effort to control and/or eliminate biological contaminants, such as unwanted bacteria and other forms of undesirable microorganisms, found in water, aqueous-based solutions, aqueous-based amalgamations, some diesel compounds, liquid foodstuffs, marine ballast water, produced water, flowback water and/or combinations thereof or other fluid mixtures containing at least one polar substance known to those of ordinary skill in the art.

For example, traditional thermal treatments, such as pasteurization, are commonly used in the food industry to ensure food safety and meet extended shelf-life goals. However, thermal treatments are known to cause unwanted changes in the nutritional, organoleptic and functional properties of many food products. Consequently, the food industry is constantly looking for alternative non-thermal processing technologies to deal with food quality and safety issues while protecting the sensory attributes of the products involved. Other modern methods of food preservation include exposing such products to various types of radiation, such as ultraviolet light. While many of these methods of controlling unwanted microorganisms in food products have proven to be quite desirable, they can substantially alter the nature of the food so that the quality and taste of the processed foods are less desirable. Microwave cooking subjects food to a magnetic field; however, as mentioned above, the induced thermal effect kills microorganisms while substantially altering the character of the food.

Other alternative processing technologies such as chemical additives, high intensity ultrasound processing, high hydrostatic pressure processing, pulsed electric fields processing, and ozone processing are some of the most common fluid processing technologies in food industry to control pathogenic and spoilage bacteria in foods. Although “non-thermal” is a term associated with some of these technologies, most cause a rise in the temperature of aqueous-based fluids and the reduction in microbial population is often a synergistic effect associated with temperature elevation. Moreover, some of these technologies can accelerate enzymatic or non-enzymatic reactions in foods that can affect the sensory properties of foods. For example, exposure of milk to UV light can trigger oxidative changes that is responsible for subsequent development of oxidized flavor. Conventional ozone generators (either corona discharge or UV lamps) typically do not scale down and are impractical for low flow rate water treatment regimens (i.e., for treating 500 L/hr. or less). The food industry is actively looking for a suitable non-thermal technology than can be used to achieve a 5-log reduction of pathogenic and spoilage bacteria without causing a detrimental effect to nutritional, sensory quality and/or other characteristics of foods.

Limited studies have been carried out on the application of the use of oscillating magnetic fields in conditioning fluids where reductions in the number of microorganisms in fluids containing at least one polar substance can be achieved by exposing the fluids to high intensity magnetic fields for a very short time without a significant increase in temperature.

In U.S. Pat. No. 1,863,222, Hoermann et al. described a method of exposing food and other products with high frequency oscillations by placing them in the conductive pathway of a high frequency electrical circuit. In U.S. Pat. No. 3,876,373, Glyptis described a method and apparatus for sterilizing matter by inhibiting the reproduction of organisms by the use of a plasma discharge or by electromagnetic excitation to destroy or disrupt the functioning of the DNA molecule of the organisms.

Magnetic fields have been used previously in conjunction with certain food processing steps. For example, in U.S. Pat. No. 4,042,325, Tensmeyer described a method of killing microorganisms inside a container by directing an electromagnetic field into the container, inducing a plasma by focusing a single-pulsed, high-power laser beam into the electromagnetic field and exposing the inside of the container to the plasma for about 1.0 millisecond to about 1.0 second by sustaining the plasma with the electromagnetic field.

In U.S. Pat. No. 4,524,079, Hofmann described a method and apparatus utilizing moderate frequency, high intensity magnetic fields as a non-thermal process to inactivate some selected microorganisms within a generally non-electrically conductive environment. Destruction of microorganisms within food (disposed in a container having relatively high electrical resistivity and subjected to an oscillating magnetic field) was accomplished within very short time periods during which no significant rise in temperature was observed in the food. The food was sterilized without any detectable change in its character, without a plasma being produced and without the addition of chemicals.

According to Hofmann, exposing various food products to a high intensity, moderate frequency oscillating magnetic field for very short time periods makes his method of controlling such biological contaminants effective as microorganisms were either destroyed or reproductively inactivated. He found that during the batch treatment of orange juice, milk and yogurt, the short period of time these food products were subjected to an oscillating magnetic field resulted in minimal heating of the food and except for destruction of the microorganisms, the food was substantially unaltered. He described a single pulse of the magnetic field as generally having the capacity to decrease the microorganism population by at least about two orders of magnitude, and subjecting the material to additional pulses more closely approached substantially complete sterility, yet the taste of the food was unaltered.

However, Hofmann merely placed food products packaged in non-conductive containers in a high intensity magnet to kill bacteria and sterilized only the food products within the containers. While this non-thermal method of controlling microorganisms in liquid food proved to be highly effective, the operational challenges associated with the batch treatment of individually packaged food products can be remedied by the bulk conditioning of food materials flowing through a processing system.

Most biological contaminants regulate their water intake through osmosis via the electrical charge of fats and proteins in their surface membranes. Directing biological contaminants to pass through concentrated magnetic energy may overwhelm the electrical fields and charges in the surface membranes of these microorganisms and drive them to an imbalanced state, weakening their cell walls and destroying the membranes. Unlike chemical treatment and other means of controlling many biological contaminants, such organisms may not develop immunity to the presently claimed and/or disclosed inventive concepts of fluid conditioning.

In addition to the food industry, other industries are also looking for ways to control and/or eliminate unwanted bacteria and undesirable microorganisms in fluids containing at least one polar substance. Ballast water brought onboard an empty ocean going vessel to stabilize the ship at its port of departure typically contains a variety of non-native biological materials, including plants, viruses and bacteria that can cause extensive ecological and economic damage to aquatic ecosystems when untreated prior to its discharge at a destination port. In the oilfield, water that is injected into a formation is typically treated to prevent the reservoir from being flooded with water containing sulfate-reducing bacteria that can result in the in-situ development of H2S concentrations during the waterflood. Once sulfate-reducing bacteria have been introduced into a reservoir, they are essentially impossible to kill; however, and result in lower quality hydrocarbons being produced by the formation as well as posing a number of health and environmental dangers for operators.

The presently claimed and/or disclosed inventive concepts for conditioning fluids provide non-contact conditioning that can be delivered to a fluid flowing through a conduit in any process, without any need for engineering modifications. In addition, this method of conditioning fluids may have no moving parts and may be scalable to configure to a broad range of flow rates. Further, heat generation that has been a major limitation in providing conditioning for flowing fluids is virtually eliminated.

Fluid mixtures containing at least one biological contaminant may be directed through the magnetically energized conduit without the addition of chemical additives, and the process may be utilized to destroy the membranes of biological contaminants flowing through the magnetically energized conduit. Typically, a fluid may be conditioned at ambient temperature, but conditioning may also occur at a wide range of temperatures.

The intensity of the pulsed magnetic energy that is used may be as low as 0.25 Tesla and may exceed 1.5 Tesla, and preferably the intensity of the magnetic field is between 0.75 and 1.0 Tesla. The actual intensity of the magnetic field used depends on the properties of the fluid being conditioned, including the resistivity of the material and its thickness, with higher intensities typically utilized for materials of lower resistivities and greater viscosity. No direct relationship has currently been derived relating magnetic energy intensity to various types of materials. Sufficient destruction of microorganisms may be effected by adjusting parameters, such as exposure time, which is a function of the flow rate through the distinct regions of concentrated fluid conditioning energy, as well as the repetition rate and uniformity of the pulsed outputs of magnetic energy.

Total exposure time of fluid mixtures containing at least one polar substance to the magnetic energy is minimal, ranging from about 1,000 milliseconds up to about 10,000 milliseconds. With reference to the above-described process, exposure time can be considered the number of pulses multiplied by the duration of each pulse as the liquid flows through each region of concentrated energy. A single pulse generally decreases the population of a microorganism by about two orders of magnitude; however, additional pulses may be used to affect a greater degree of conditioning, and, typically, fluids are subjected to between about 100 pulses and about 1,000 pulses.

Regardless of the intensity of the magnetic energy and the number of pulses, a fluid mixture containing at least one polar substance will not be significantly heated, and will normally be subjected to at least 100 pulses. Desirably, the fluid mixture will not be heated more than 1 degree C. by the magnetic conditioning procedure.

In many instances, directing a fluid mixture containing at least one polar substance and at least one dissimilar material to pass through magnetic energy may neutralize the electrical charges of at least one dissimilar material in the fluid, rendering the dissimilar material non-adhesive and enhancing the clarification of the fluid. Water utilized as a heat transfer medium in thermal exchange systems may be directed through concentrated magnetic energy to retard the formation of scale and other heat insulating deposits in such thermal exchange systems. Neutralizing the charges of suspended solids adhering to small oil droplets that tend to keep the oil suspended in water may disrupt the stability of some emulsions. Increasing the interfacial tension between water and oil allows small oil droplets to coalesce into larger droplets, float out of the water and be removed by separation apparatus. Charged electrodes may also be used in concert with magnetic fluid conditioning to break many bonds that tend to create emulsions. Similarly, water may be removed from hydrocarbon fluids.

Directing a fluid mixture to pass through the presently claimed and/or disclosed inventive concepts may cause at least one dissimilar material in the fluid mixture to be repelled from the fluid and facilitate its removal from the fluid, and thereby reduce the amount of flocculants and/or coagulants required for adequate dewatering processes so that drier solids and clearer filtrate may be discharged from dewatering equipment.

At least one chemical dispersing apparatus having a capacity to distribute a supply of at least one fluid conditioning chemical into a fluid directed to pass through magnetic energy may be utilized to disperse a supply of at least one chemical into a fluid mixture containing at least one polar substance upstream of the magnetically conductive conduit, downstream of the magnetically conductive conduit, upstream of the separation apparatus, and/or downstream of the separation apparatus.

Fluid conditioning chemicals may be selected from a group consisting of, but not limited to, algaecides, biocides, scale retardants, coagulants and flocculants, pesticides, fertilizers, surfactants, petroleum production fluid additives, fuel additives, lubricant additives, ambient air, oxygen, hydrogen, ozone and hydrogen peroxide. As used herein, charged electrodes generating oxygen and hydrogen bubbles and hydroxyl radicals in the electrolysis of aqueous-based fluid mixtures may be included as a chemical dispersing apparatus.

Algaecides may include, but are not limited to, copper sulfate, cupric sulfate, chelated copper, quaternary ammonia compounds and equivalents. Biocides, may include, but are not limited to, chlorine, hypochlorite solutions, sodium dichloro-s-triazinetrione, trichloro-s-triazinetrione, hypochlorous acid, halogenated hydantoin compounds and equivalents. Scale retardants may include, but are not limited to, ion-exchanger resins, analcime, chabazite, clintptilolite, heulandite, natrolite, phillipsite, stilbite and equivalents. Coagulants and flocculants may include, but are not limited to, multivalent cations such as aluminum, iron, calcium or magnesium, long-chain polymer flocculants such as modified polyacrylamides, and equivalents. Pesticides may include, but are not limited to, organochlorides, such as dichlorodiphenylethanes and cyclodiene compounds, organophosphates, carabamates, such as thiocarbamate and dithiocarbamates, pheoxy and benzoic acid herbicides, triazines, ureas, chloroacetanilides, glyphosate and equivalents. Fertilizers may include, but are not limited to, nitrogen fertilizers, such as anhydrous ammonium nitrate and urea, potash, and equivalents. Surfactants such as detergents, wetting agents, emulsifiers, foaming agents and dispersants may include, but are not limited to, ammonium lauryl sulfate, sulfate, sodium lauryl ether sulfate, sodium myreth sulfate, dioctyl sodium sulfosuccinate, perfluorooctanesulfonate, perfluorobutanesulfonate, linear alkylbenzene sulfonates, perfluorononanoate, octenidine dihydrochloride, perfluorononanoate, alkyltrimethylammonium salts, cocamidopropyl hydroxysultaine, cocamidopropyl betaine, polyoxyethylene glycol, alkyl ethers, octaethylene glycol monododecyl ether, pentaethylene glycol monododecyl ether, polyoxypropylene glycol alkyl ethers, polyoxyethylene glycol octylphenol ethers, polyoxyethylene glycol alkylphenol ethers, dodecyldimethylamine oxide, polyethylene glycol and equivalents.

In some instances, chemical pretreatment may hamper the efficiency of separation apparatus, such as screening apparatus, hydrocyclones, desanders and desilters that tend to blind off with chemically treated fluid mixtures. Improved removal of at least one dissimilar material from a fluid may be achieved by directing a fluid mixture containing at least one polar substance free of coagulants or flocculants to pass through the magnetically conductive conduit upstream of such separation apparatus to enhance the separation of at least one dissimilar material from the fluid mixture.

At least one fluid conditioning apparatus having a capacity to alter the flow of a fluid directed to pass through magnetic energy may be utilized to alter the flow of a fluid mixture containing at least one polar substance upstream of the magnetically conductive conduit, downstream of the magnetically conductive conduit, upstream of the separation apparatus, and/or downstream of the separation apparatus. Fluid conditioning apparatus may be selected from a group consisting of, but not limited to, pumps, blowers, vortex inducing equipment, static mixing devices and dynamic mixing apparatus to create turbulence in a flow of a fluid or laminar flow conditioners to remove turbulence from a flow of a fluid. Further, the static mixing devices can be positioned in a sequence in which the static mixing devices have different configurations. For example, a first static mixing device in the sequence may have a first configuration, a second static mixing device in the sequence may have a second configuration, and a third static mixing device in the sequence may have a third configuration that is different from the first and second configurations. Also, the fluid conditioning apparatus, such as the static mixing devices, may be supported by the magnetically conductive nucleus 39, described above.

The foregoing description of various embodiments, constrictions, and uses of presently claimed and/or disclosed inventive concepts has been for the purpose of explanation and illustration and should not be considered as limiting to the breadth and scope of the presently claimed and/or disclosed inventive concepts. It will be appreciated by those skilled in the art that modifications and changes may be made without departing from the essence and scope of the presently claimed and/or disclosed inventive concepts. For example, additional embodiments of energized coils may be utilized to induce a magnetic field for fluid conditioning. Therefore, it is contemplated that the appended claims will cover any modifications or embodiments that fall within the broad scope and/or obvious modifications and improvements of the presently claimed and/or disclosed inventive concepts.

1. A method of increasing the rate by which a dissimilar material separates in a fluid mixture, having the steps of:
passing a first fluid mixture containing at least one polar substance and at least one dissimilar material through a magnetically conductive conduit having magnetic energy directed along the longitudinal axis of the magnetically conductive conduit and extending through at least a portion of the first fluid mixture thereby providing a conditioned fluid medium; and
separating the conditioned fluid medium into at least two distinct phases in a separation apparatus downstream of the magnetically conductive conduit, wherein the at least one dissimilar material separates from the conditioned fluid medium at an increased rate as compared to a rate of separation of the at least one dissimilar material from the first fluid mixture.

2. The method of claim 1, further having the step of recovering the first fluid mixture from the conditioned fluid medium.

3. The method of claim 2, wherein the first fluid mixture has a reduced volume of the at least one dissimilar material.

4. The method of claim 1, further having the step of recovering the at least one dissimilar material from the conditioned fluid medium.

5. The method of claim 4, wherein the at least one dissimilar material has a reduced volume of the first fluid mixture.

6. The method of claim 1, wherein the at least one dissimilar material is selected from the group consisting of hydrocarbon compounds, autotrophic organisms, chemical compounds, solid materials, fats, biological contaminants and combinations thereof.

7. The method of claim 1, wherein the viscosity of the conditioned fluid medium is lower than the viscosity of the first fluid mixture.

8. The method of claim 1, wherein a particle size of the at least one dissimilar material in the conditioned fluid medium is larger than a particle size of the at least one dissimilar material in the first fluid mixture.

9-10. (canceled)

11. The method of claim 1, wherein at least one chemical compound is dispersed in the first fluid mixture.

12. The method of claim 1, wherein at least one chemical compound is dispersed in the conditioned fluid medium.

13-46. (canceled)

47. A method of separating at least one dissimilar material from a fluid mixture, having the steps of:
establishing a flow of a first fluid mixture containing at least one polar substance and at least one dissimilar material through a magnetically conductive conduit having magnetic energy directed along the longitudinal axis of the magnetically conductive conduit and extending through at least a portion of the first fluid mixture thereby providing a conditioned fluid medium; and
directing a flow of at least a portion of the conditioned fluid medium through a separation apparatus.

48. The method of claim 47, wherein the conditioned fluid medium is heated upstream of the separation apparatus.

49. The method of claim 47, wherein at least one chemical compound is dispersed in the first fluid mixture.

50. The method of claim 47, wherein at least one chemical compound is dispersed in the conditioned fluid medium.

51-60. (canceled)

61. An apparatus for separating at least one dissimilar material from a fluid mixture containing at least one polar substance, including:
a magnetically conductive conduit having magnetic energy directed along the longitudinal axis of the magnetically conductive conduit and extending through at least a portion of the magnetically conductive conduit; and
a separation apparatus downstream of the magnetically conductive conduit, wherein the fluid mixture containing at least one polar substance and at least one dissimilar material is capable of flowing through the magnetically conductive conduit and through the separation unit.

62. The apparatus of claim 61, wherein the magnetically conductive conduit further has a fluid entry port at the proximal end of the magnetically conductive conduit, a fluid discharge port at the distal end of the magnetically conductive conduit and a fluid impervious boundary wall extending between the fluid entry port and the fluid discharge port, an inner surface of the boundary wall establishing a fluid flow path extending along the longitudinal axis of the conduit.

63. The apparatus of claim 62, wherein the magnetically conductive conduit further has at least one electrical conductor having a first conductor lead and a second conductor lead, the electrical conductor coiled with at least one turn to form at least one uninterrupted coil of electrical conductor, each coil forming at least one layer of coiled electrical conductor.

64. The apparatus of claim 63, wherein the magnetically conductive conduit further has at least one coiled electrical conductor encircling the magnetically conductive conduit, wherein the at least one coiled electrical conductor sleeves at least a section of an outer surface of the magnetically conductive conduit with at least one turn of the electrical conductor oriented substantially orthogonal to the fluid flow path extending through the conduit.

65. The apparatus of claim 64, wherein the magnetically conductive conduit further has at least one electrical power supply operably connected to at least one of the first and second conductor leads, wherein the at least one coiled electrical conductor is thereby energized to provide a magnetic field having lines of flux directed along the longitudinal axis of the magnetically energized conduit.

66. The apparatus of claim 65, wherein the magnetic field is concentrated in a plurality of distinct areas along the longitudinal axis of the magnetically conductive conduit.

67. The apparatus of claim 61, wherein the separation apparatus further has at least one inlet port, at least one outlet port and a fluid impervious boundary wall extending between the at least one inlet port and the at least one outlet port.

68. The apparatus of claim 61, wherein the separation apparatus has a fluid impervious boundary wall having an inner surface, an inlet port for receiving a magnetically conditioned fluid medium, a first outlet port for discharging a first amount of the conditioned fluid medium having a reduced volume of the at least one dissimilar material and a second outlet port for discharging the at least one dissimilar material containing a reduced volume of the conditioned fluid medium.

69. The apparatus of claim 61, wherein the separation apparatus has a fluid impervious boundary wall having an inner surface, an inlet port for receiving a magnetically conditioned fluid medium, and at least one outlet port for discharging an amount of the conditioned fluid medium containing a reduced volume of the at least one dissimilar material.

70. The apparatus of claim 61, wherein a magnetically energized conduit is disposed within the separation apparatus.

71-105. (canceled)
